(19) United States
(12) Patent Application Publication
(10) Pub. No.: US 2026/0140929 A1
(43) Pub. Date: May 21, 2026

(54) DYNAMIC UPDATES TO MACHINE LEARNING MODEL CARDS BASED ON MODEL CHANGES

(71) Applicant: NVIDIA Corporation, Santa Clara, CA (US)

(72) Inventors: Ruthie D. Lyle, Durham, NC (US); Carl Everett Lacey, JR., Palo Alto, CA (US); Michael Boone, Los Gatos, CA (US); Nikki Delight Pope, Henderson, NV (US)

(21) Appl. No.: 18/952,873

(22) Filed: Nov. 19, 2024

(51) Int. Cl. G06F 16/21; G06F 11/34; G06F 16/23

(52) U.S. Cl. CPC G06F 16/219; G06F 11/3447; G06F 16/2358

(57) ABSTRACT

In various examples, updating model cards with information associated with modifications to machine learning models are described herein. For instance, systems and methods described herein may automatically update model cards with supplemental information about modifications that occur to models. To update a model card, the unique identifier may be used to identify that a modification occurred to a model—such as by performing fine-tuning, optimization, quantization, and/or any other modifying technique—in order to generate a new version of the model. Supplemental information about the modification is then obtained, such as by decoding the unique identifier, testing the new version of the model, and/or using data describing how the model was modified. The model card may then automatically be updated with the supplemental information. Additionally, this process may continue to repeat as additional modifications occur to the model to generate new versions of the model.

### BACKGROUND

Online repositories allow users to download, modify (e.g., update, optimize, etc.), and share models (e.g., machine learning models, neural networks, classifiers, etc.). For example, a user may use an online repository to modify a first version of a model—such as by performing fine-tuning, optimization, and/or quantization—in order to generate a second version of the model. The user is then able to share the second version of the model with additional users using the online repository. However, conventional systems that provide online repositories for models may not provide any mechanisms and/or sufficient mechanisms to track and/or verify modifications that are performed on the models. For example, if a user generates a new version of a model using fine-tuning, other users may be unable to identify a dataset used to perform the fine-tuning, an accuracy of the model after performing the fine-tuning, and/or that the new version of the model was generated by performing the fine-tuning. This may make it difficult for the conventional systems to track the integrity and/or origins of models.

To try and cure these deficiencies, some conventional systems may store model cards that include information about available models. For instance, a model card may contain various information about a particular model—such as the model's development process, training data, performance metrics, potential biases, limitations, intended use cases, and/or out-of-scope applications—which may allow the end users to make informed decisions about the model's deployment and/or use. However, when models are modified to generate new versions of the models, these model cards may not be updated with information describing the modifications. Additionally, even if model cards are updated, the conventional systems require users to manually identify information associated with the modifications and input that information into the model cards. As such, the conventional systems are prone to errors, such as by users inputting incorrect information into the model cards and/or not identifying pertinent information describing the modifications.

### SUMMARY

Embodiments of the present disclosure relate to identifier-based tracking and validation of machine learning model modifications. For instance, systems and methods described herein may generate unique identifiers—such as checksums, hashes, and/or the like—that track modifications to models. For example, if a first version of a model is modified (e.g., updated, changed, optimized, augmented, etc.) to generate a second version of the model—such as by performing fine-tuning, optimization, quantization, and/or any other modifying technique—data representing the modifications may be obtained. This data may then be used to generate information (e.g., text, messages, notes, comments, etc.) describing the modifications. Additionally, the information may be encoded using one or more encoders and/or processed using one or more algorithms (e.g., one or more hashing algorithms) to generate a unique identifier for the second version of the model. Systems and methods are then described that use the unique identifiers to perform various tasks, such as verifying the integrities of the various versions of the models, providing information about the modifications, and/or the like.

In contrast to conventional systems, the systems of the present disclosure, in some embodiments, generate the unique identifiers that may be used to track modifications that occurred with respect to models, verify integrities of the models, and/or identify specific versions of models for further modification and/or use. For example, if a user is attempting to obtain a model from an online repository, the user is able to use the unique identifiers to determine information such as how versions of the model were modified, performance scores for the versions of the model, dates the versions of the model were generated, identifiers of who generated the versions of the model, and/or any other modification information. As such, the user may use the unique identifiers to select a version of the model to retrieve and/or verify an integrity of the model after retrieval. In other words, the systems of the present disclosure may use the unique identifiers to guarantee the integrity and/or origins of models that are provided using the online repository.

Embodiments of the present disclosure further relate to dynamic updates to machine learning model cards based on model changes. For instance, systems and methods described herein may automatically update model cards with supplemental information about modifications that occur to models. To update a model card, the unique identifier may be used to identify that a modification occurred to a model—such as by performing fine-tuning, optimization, quantization, and/or any other modifying technique—in order to generate a new version of the model. Supplemental information about the modification is then obtained, such as by decoding the unique identifier, testing the new version of the model, and/or using data describing how the model was modified. The model card associated with the model may then automatically be updated with the supplemental information. Additionally, this process may continue to repeat as additional modifications occur to the model to generate new versions of the model.

In contrast to conventional systems, the systems of the present disclosure, in some embodiments, automatically determine that modifications occurred to models, obtain supplemental information associated with the modifications, and then update model cards for the models using the supplemental information. For instance, and as described above, conventional systems may store model cards that include information about initial versions of model. However, the model cards stored by the conventional systems are not usually updated when models are modified and/or require user input for updating, which is prone to error. As such, the systems of the present disclosure provide improvements in that the models cards are continuously updated to include supplemental information about newer versions of models. Additionally, by obtaining the supplemental information using the techniques described herein, the systems of the present disclosure ensure that the model cards are accurately updated to reflect actual characteristics and/or performance information about the models.

### BRIEF DESCRIPTION OF THE DRAWINGS

The present systems and methods for tracking and verifying modifications of machine learning models are described in detail below with reference to the attached drawing figures, wherein:

FIG. 1 illustrates an example of a process for using unique identifiers to track and verify modifications to models, in accordance with some embodiments of the present disclosure;

FIG. 2 illustrates an example of storing different versions of a model that have been modified, in accordance with some embodiments of the present disclosure;

FIG. 3 illustrates an example of obtaining data representing characteristics and/or modifications associated with a model, in accordance with some embodiments of the present disclosure;

FIG. 4 illustrates an example of generating structured information associated with a version of a model, in accordance with some embodiments of the present disclosure;

FIG. 5 illustrates an example of generating unique identifiers associated with various versions of a model, in accordance with some embodiments of the present disclosure;

FIG. 6 illustrates an example of providing structured information associated with various versions of a model, in accordance with some embodiments of the present disclosure;

FIG. 7 illustrates an example of a process for automatically updating model cards to include supplemental information for modifications to models, in accordance with some embodiments of the present disclosure;

FIG. 8 illustrates an example of decoding a unique identifier in order to obtain supplemental information associated with a modification to a model, in accordance with some embodiments of the present disclosure;

FIG. 9 illustrates an example of testing a model to determine performance information, in accordance with some embodiments of the present disclosure;

FIGS. 10A-10C illustrate an example of updating a model card to include supplemental information associated with modifications to a model, in accordance with some embodiments of the present disclosure;

FIG. 11 illustrates a flow diagram showing a method for generating a unique identifier associated with a modification to a model, in accordance with some embodiments of the present disclosure;

FIG. 12 illustrates a flow diagram showing a method for using a unique identifier to provide information associated with a model, in accordance with some embodiments of the present disclosure;

FIG. 13 illustrates a flow diagram showing a method for using a unique identifier to verify a model, in accordance with some embodiments of the present disclosure;

FIGS. 14-15 illustrate flow diagrams showing methods for updating model cards with information describing modifications to models, in accordance with some embodiments of the present disclosure;

FIG. 16 is a block diagram of an example computing device suitable for use in implementing at least some embodiments of the present disclosure; and

FIG. 17 is a block diagram of an example data center suitable for use in implementing at least some embodiments of the present disclosure.

### DETAILED DESCRIPTION

Systems and methods are disclosed related to tracking and verifying modifications of machine learning models. For instance, a system(s) may provide models (e.g., machine learning models, neural networks, classifiers, etc.) using one or more techniques, such as by managing one or more repositories, one or more libraries, one or more archives, one or more databases, and/or the like. For example, the system(s) may provide a model repository that allows users to at least store, share, manage, access, modify, and/or use models. As described herein, models may be modified (e.g., updated, changed, optimized, augmented, etc.) using one or more techniques. For example, a model may be modified by at least fine-tuning the model to perform a specific task, optimizing the model to execute using specific hardware components (e.g., specific types of processors, specific types of memory, etc.), hyperparameter tuning the model, performing quantization on the model, and/or by performing any other type of model modification technique.

For a specific example, the system(s) may receive and then store a first version of a model using a model repository. One or more first users may then use one or more first computing devices to access the first version of the model on the model repository, modify the first version of the model using one or more techniques to generate a second version of the model, and then upload the second version of the model back to the model repository. Next, one or more second users may use one or more second computing devices to access the first version or the second version of the model on the model repository, modify the first version or the second version of the model using one or more techniques to generate a third version of the model, and then upload the third version of the model back to the model repository. These processes may then continue to repeat such that the model repository stores versions of the model that have been modified by different users using various techniques. Because of this, it may be important for the system(s) to provide mechanisms for at least tracking and/or verifying modifications that occur to the models stored on the model repository.

As such, when a model is modified to a new version, the system(s) may generate, receive, obtain, and/or retrieve data representing characteristics associated with the model, modifications that occurred with respect to the model, information for users that performed the modifications on the model, and/or any other information associated with the new version of the model. For instance, in some examples, the data may represent an architecture associated with the model, one or more datasets used to train the model, one or more risk scores associated with the model, one or more licenses associated with the model, one or more performance scores associated with the model, hardware the model was optimized to perform on, one or more changes that occurred with respect to the model, an identity of a user that performed the modifications, and/or a date and/or time that the modifications occurred. In some examples, the system(s) may automatically generate, receive, obtain, and/or retrieve the data during and/or after the model is modified. In some examples, the system(s) may generate, receive, obtain, and/or retrieve the data based on one or more events, such as the new version of the model being uploaded.

The system(s) may then process at least a portion of the data to generate structured information describing the characteristics and/or modifications associated with the new version of the model. For instance, in some examples, the system(s) may generate information (e.g., messages) describing a summary of the changes made (e.g., fine-tuned on a new dataset, quantized for inference using a specific type of processor, etc.), information describing details about the modifications to the model (e.g., changes in architecture, changes in risk scores, changes in licenses, etc.), information describing performance improvements associated with the model (e.g., accuracy increases, accuracy increases on specific hardware, etc.), information describing the date the modifications occurred, information describing the user(s) that performed the modifications, and/or information describing any other characteristic and/or modification associated with the model.

The system(s) may then generate a unique identifier that at least tracks the modifications associated with the new version of the model. As described herein, the unique identifier may include, but is not limited to, a checksum, a hash, a code, an alphabetic identifier, a numerical identifier, an alphanumerical identifier, and/or any other type of identifier that may be used to track the modifications associated with the model. For example, the system(s) may use one or more encoders to encode at least a portion of the structured information describing the characteristics and/or the modifications associated with the new version of the model. In some examples, the encoder(s) may encode the structured information into a compressed format and/or a binary, which may also be referred to as encoded information. The system(s) may then combine the encoded information with the model's configuration to generate the unique identifier associated with the model. For example, the system(s) may use one or more hashing algorithms (e.g., SHA-256, Blake3, etc.) to generate a checksum based on the combined encoded information and model's configuration. By performing such processes, the unique identifier may represent at least the information describing the characteristics and/or the modifications associated with the new version of the model.

The system(s) may then store the unique identifiers and/or the data in association with the models using one or more techniques. For instance, in some examples, the system(s) may store the unique identifiers and/or the data along with the models, such as using the model repository. Additionally, or alternatively, in some examples, the system(s) may send the unique identifiers, the data, and/or the models to one or more external platforms that are also used to store and/or provide the models. In other words, the system(s) may synchronize the modifications made to the models with the other external platforms.

As described herein, the system(s) and/or one or more other computing devices may then use the unique identifiers to perform one or more tasks. For instance, the system(s) and/or the computing device(s) may use a unique identifier associated with a model to at least verify an integrity of the model. As described herein, in some examples, the system(s) and/or the computing device(s) may verify the integrity of the model by comparing a newly generated unique identifier to the unique identifier associated with the model. For example, the system(s) may provide the model, the data, and the unique identifier to a computing device, such as in response to receiving a request. The computing device(s) may then use one or more of the techniques described herein to generate a new unique identifier associated with the model. Additionally, the computing device(s) may verify the integrity of the model when the unique identifiers match and/or not verify the integrity of the model when the unique identifiers do not match. This is because, in some examples, the unique identifiers may not match when the model has been further modified (e.g., tampered with, such as by performing unauthorized modifications).

Additionally, the system(s) may use unique identifiers to provide information associated with available models (e.g., models stored on the model repository). For a first example, the system(s) may use a unique identifier associated with a version of a model to retrieve the information describing the characteristics and/or modifications associated with the model. In some examples, such as when the unique identifier includes a checksum, the system(s) may retrieve the information by decoding the checksum using one or more decoders. The system(s) may then provide the information to one or more users. This way, the user(s) is able to identify important information associated with the version of the model, such as the modifications made to the model, the characteristics of the model that were modified, the impact of the modifications on performance of the model, who made the modifications, when the modifications were made, and/or the like.

For a second example, the system(s) may use unique identifiers associated with multiple versions of a model to retrieve information describing characteristics and/or modifications associated with one or more (e.g., each) of the versions. The system(s) may then provide this information to one or more users, where the information provides a clear audit trail of the history of the model. For instance, the user(s) may use the information to identify changes that occurred at each modification step associated with the model. Additionally, the user(s) may use the information to identify a version of the model to retrieve for performing one or more tasks. For instance, if the newest version of the model includes modifications that need to be reverted, then the user(s) may use the information to identify which version introduced the modifications and/or retrieve the previous version of the model that does not include the modifications.

Additionally, in some examples, the system(s) may use other techniques to track modifications that occur to models. For instance, the system(s) may generate and/or update model cards associated with the models. As described herein, model cards may initially include fields that provide initial information associated with models, such as fields for attributes, model architectures, intended use cases, out-of-scope applications, inputs, outputs, expected users, model performance for different groups, training, limitations, computing requirements, and/or the like. Additionally, an attribute may include, but is not limited to, a name and/or an identifier of the model, one or more names and/or identifiers of one or more datasets used to train the model, one or more sizes of the dataset(s), a number of epochs used for the training, a license type associated with the model, one or more risk scores associated with the model, one or more bias scores associated with the model, one or more losses associated with the model, and/or any other type of attribute.

The system(s) may then update the model cards to include information associated with modifications that occur with respect to the models. For instance, the system(s) may modify the model cards to include additional fields that represent information related to the modifications, such as types of modifications, the unique identifiers associated with the models, the dates of the modifications, the performance information associated with the modifications (e.g., accuracy scores, precision scores, recall scores, etc.), dates when the modified models are deployed, hardware the models are optimized to execute on, performance characteristics associated with the models executing on the hardware (e.g., throughputs, latencies, power consumptions, memory utilizations, etc.), and/or any other information associated with the modifications.

For instance, to update a model card for a model, the system(s) may initially determine that the model is being updated and/or has been updated to generate a new version of the model. In some examples, the system(s) may determine that the model has been updated based on the unique identifier associated with the new version of the model. For example, the system(s) may determine that the unique identifier is new, such that the unique identifier indices that the modification occurred. In some examples, the system(s) may determine that the model has been updated based on determining that a user is using a computing device to modify the model and/or already used the computing device to modify the model. Still, in some examples, the system(s) may determine that the model has been updated based on the new version of the model being uploaded to the system(s) (and/or another external repository). While these are just a few example techniques for how the system(s) may determine that the model has been updated, in other examples, the system(s) may use additional and/or alternative techniques.

The system(s) may then determine supplemental information associated with the modifications that occurred with regard to the model. In some examples, the system(s) may determine at least a portion of the supplemental information using the unique identifier. For example, the system(s) may decode the unique identifier in order to obtain the structured information associated with the new version of the model. In some examples, the system may determine at least a portion of the supplemental information using the data representing the characteristics associated with the model, the modifications that occurred with respect to the model, and/or the information for the users that performed the modifications on the model, where the data was originally obtained to generate the unique identifier. Still, in some examples, the system(s) may determine at least a portion of the supplemental information based on performing one or more tests associated with the model, such as to determine performance information associated with the new version of the model. While these are just a few example techniques for how the system(s) may determine the supplemental information associated with the modifications to the model, in other examples, the system(s) may use additional and/or alternative techniques.

The system(s) may then use the supplemental information to update the model card associated with the model. For example, the system(s) may identify the model card associated with the model, such as by using an identifier of the model, an identifier of the model card, and/or any other type of identifier. The system(s) may then add at least a portion of the supplemental information to the model card. Additionally, these processes may continue to repeat as the model is modified to generate additional versions of the model. For example, if the model is optimized for ten different types of processors, then the system(s) may modify the model card to include supplemental information associated with each of the optimizations of the model. Furthermore, these processes may continue to repeat in order to updated model cards for any number of models.

In some examples, the system(s) may generate a single model card that is then updated with the supplemental information associated with each of the modifications that occur to a model. However, in other examples, the system(s) may generate multiple model cards associated with the modifications that occur with respect to the model. For a first example, the system(s) may generate a first model card that includes the initial information associated with a first version of a model and supplemental information associated with a first modification to generate a second version of the model, a second model that includes the initial information associated with the first version of the model and supplemental information associated with a second modification to generate a third version of the model, and/or so forth. For a second example, the system(s) may generate a first model card that includes first modifications for a first chain modifications that are used to generate versions of a model, a second model card that includes second modifications for a second chain of modifications that are used to generated additional versions of the model, and/or so forth.

As described herein, the system(s) may then perform one or more processes using the model cards. For instance, in some examples, and similar to the unique identifiers, the system(s) may locally store the model cards in association with the models and/or send the model cards to one or more external platforms that are also used to store and/or provide the models. In other words, the system(s) may synchronize the updates to the model cards with the external platforms. Additionally, in some examples, the system(s) may provide the model cards to users of the models. This way, the users are able to identify important information associated with the models, such as the modifications made to the models, the characteristics of the models that were modified (which hardware the models were optimized to execute on, etc.), the impacts of the modifications on the performances of the models, who made the modifications, when the modifications were made, and/or the like.

In some examples, the system(s) may provide one or more mechanisms to view and/or search through the model cards. For instance, since a model card may be updated to include information related to numerous modifications (e.g., hundreds of modifications, etc.) associated with a model, the system(s) may generate a user interface that allows users to quickly search through the model card to identify specific information. For a first example, such as when a model card includes a text file, the user interface may include one or more interface elements (e.g., buttons, search bars, sliders, etc.) that a user may use to select different versions of the model. The user interface may then provide information that is related to the selected versions of the model. For a second example, the system(s) may convert a text file associated with the model card to a format that is searchable by users.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing language models (e.g., small language models (SLMs) (including mini and tiny language models), large language models (LLMs)), systems implementing one or more vision language models (VLMs), systems implementing one or more multi-modal language models, systems using or deploying one or more inference microservices, systems that incorporate deploy one or more machine learning models in a service or microservice along with an OS-level virtualization package (e.g., a container), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

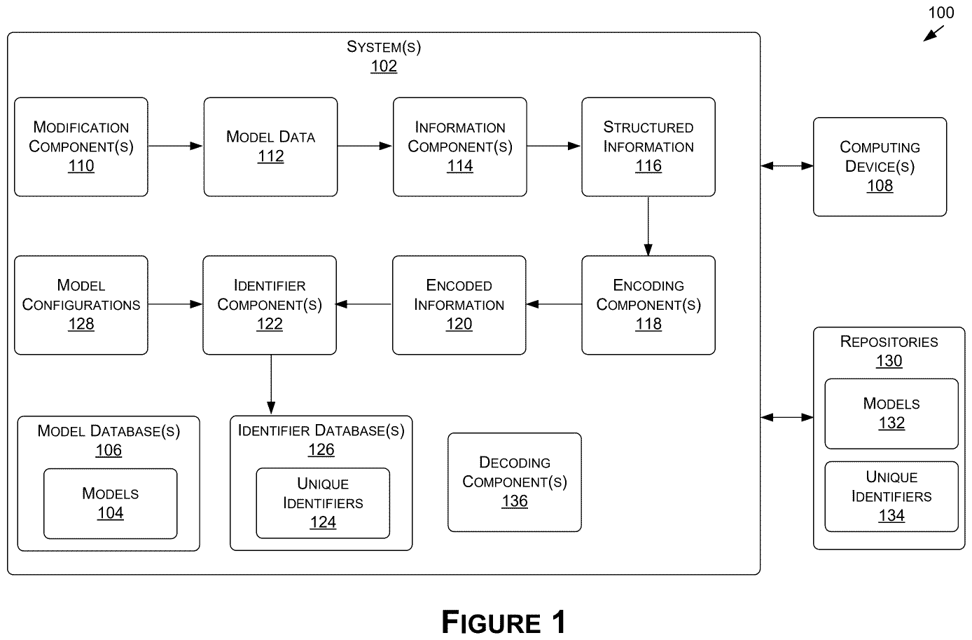

With reference to FIG. 1, FIG. 1 illustrates an example of a process 100 for using unique identifiers to track and verify modifications to models, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

The process 100 may include one or more systems 102 storing models 104 in one or more databases 106. As described herein, a model 104 may include, but is not limited to, a machine learning model, a neural network, a classifier, and/or the like. Additionally, the system(s) 102 may include, include part of, and/or manage one or more repositories, one or more libraries, one or more archives, one or more databases, and/or the like associated with the models 104. For example, the system(s) 102 may provide a model repository that allows users to at least store, share, manage, access, modify, and/or use the models 104. As described herein, the models 104 may be modified—such as updated, changed, optimized, and/or augmented—using one or more techniques. For example, a model 104 may be modified by at least fine-tuning the model 104 to perform a specific task, optimizing the model 104 to execute using specific hardware components (e.g., processors, memory, etc.), hyperparameter tuning the model 104, performing quantization on the model 104, and/or by performing any other type of model modification technique.

For a specific example, the system(s) 102 may receive and then store a first version of a model 104 using the model repository. One or more first users may then use one or more first computing devices 108 to access the first version of the model on the model repository, modify the first version of the model 104 to generate a second version of the model 104, and then upload the second version of the model 104 back to the model repository. In some examples, the first user(s) may include authorized and/or certified users that are able to modify the model 104 and/or upload the second version of the model 104 back to the model repository. In some examples, the first user(s) may modify the first version of the model 104 using any technique, such as by fine-tuning the model 104 to perform a new task and/or optimizing the model 104 to execute using specific hardware.

Next, one or more second users may use one or more second computing devices 108 to access the first version of the model 104 and/or the second version of the model 104 on the model repository, modify the first version of the model 104 and/or the second version of the model 104 to generate a third version of the model 104, and then upload the third version of the model 104 back to the model repository. In some examples, the second user(s) may include authorized and/or certified users that are able to modify the model 104 and/or upload the third version of the model 104 back to the model repository. In some examples, the second user(s) may modify the first version of the model 104 and/or the second version of the model 104 using any technique, such as by fine-tuning the model 104 to perform a new task and/or optimizing the model 104 to execute using specific hardware. These processes may then continue to repeat such that the model repository stores versions of the model 104 that have been modified by different users using various techniques.

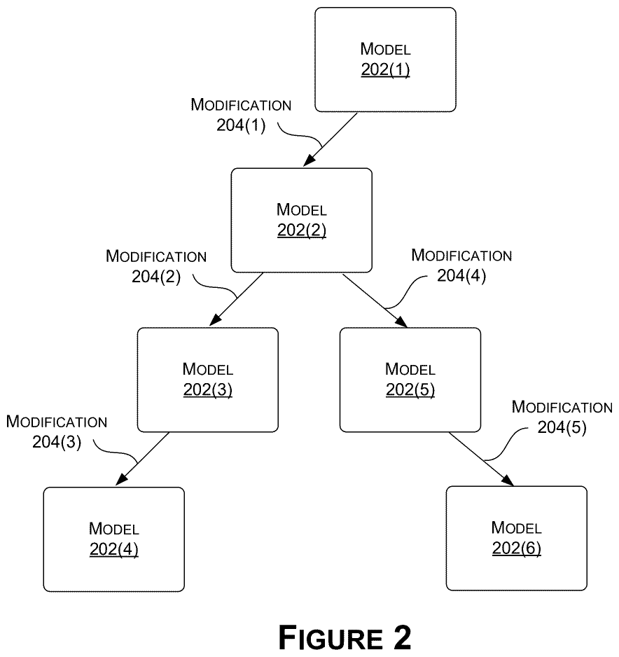

For instance, FIG. 2 illustrates an example of storing different versions of a model that have been modified, in accordance with some embodiments of the present disclosure. As shown, the model repository may store a first version of a model 202(1) (e.g., an initial version of the model), a second version of the model 202(2) that is generated by modifying 204(1) the first version of the model 202(1), a third version of the model 202(3) that is generated by modifying 204(2) the second version of the model 202(2), and a fourth version of the model 202(4) that is generated by modifying 204(3) the third version of the model 202(3). Additionally, the model repository may store a fifth version of the model 202(5) that is also generated by modifying 204(4) the second version of the model 202(2), and a sixth version of the model 202(6) that is generated by modifying 204(5) the fifth version of the model 202(5). As such, users may use computing devices to communicate with the model repository in order to access, download, retrieve, receive, modify, and/or use one or more of the versions of the model 202(1)-(6)

Referring back to the example of FIG. 1, since models 104 may be modified using different techniques and/or by various users, the system(s) 102 may provide one or more mechanisms to track, identify, and/or verify the modifications associated with the models 104. For instance, the process 100 may include using one or more modification components 110 that are configured to generate, receive, obtain, and/or retrieve model data 112 representing characteristics associated with the models 104, modifications that occurred with respect to the models 104, information for users that performed the modifications on the models 104, and/or any other information associated with the models 104. For instance, in some examples and for a version of a model 104, the model data 112 may represent an architecture associated with the model 104, one or more datasets used to train the model 104, one or more risk scores associated with the model 104, one or more licenses associated with the model 104, one or more performance scores associated with the model 104, hardware the model 104 was optimized to perform on, one or more changes that occurred with respect to the model 104, an identity of a user that performed the modifications, and/or a date and/or time that the modifications occurred. In some examples, the modification component(s) 110 may automatically generate, receive, obtain, and/or retrieve the model data 112 during and/or after the model 104 is modified. In some examples, the modification component(s) 110 may generate, receive, obtain, and/or retrieve the model data 112 based on one or more events, such as the new version of the model 104 being uploaded.

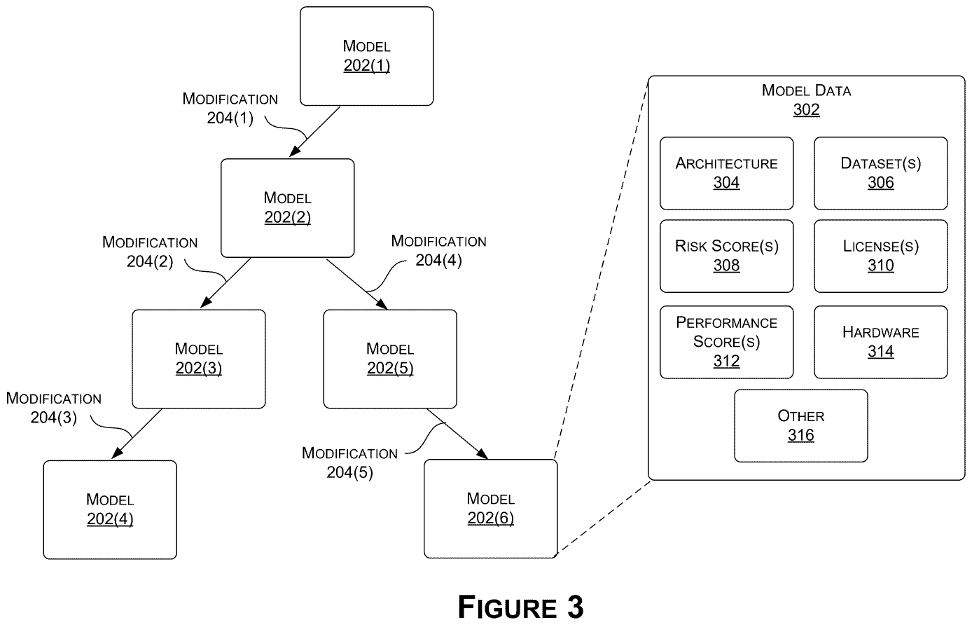

For instance, FIG. 3 illustrates an example of obtaining data representing characteristics and/or modifications associated with a model, in accordance with some embodiments of the present disclosure. In the example of FIG. 3, the modification component(s) 110 may obtain at least model data 302 (which may include, and/or be similar to, the model data 112) associated with the sixth version of the model 202(6). As shown, the model data 302 may represent at least an architecture 304 of the sixth version of the model 202(6), one or more datasets 306 used to train the sixth version of the model 202(6), one or more risk scores 308 associated with the sixth version of the model 202(6), one or more licenses 310 associated with the sixth version of the model 202(6), one or more performance scores 312 associated with the sixth version of the model 202(6), hardware 314 that the sixth version of the model 202(6) was optimized to perform on, and/or other information 316 associated with the characteristics and/or modifications associated with the sixth version of the model 202(6). In some examples, the modification component(s) 110 may obtain similar model data associated with one or more of the other versions of the model 202(1)-(5).

Referring back to the example of FIG. 1, the process 100 may include one or more information components 114 using at least a portion of the model data 112 to generate structured information 116 associated with the models 104. As described herein, structured information 116 associated with a version of a model 104 may include, but is not limited to, information (e.g., messages) describing a summary of the changes made (e.g., fine-tuned on a new dataset, quantized for inference using a specific type of processor, etc.), information describing details about the modifications to the model 104 (e.g., changes in architecture, changes in risk scores, changes in licenses, etc.), information describing performance improvements associated with the model 104 (e.g., accuracy increases, accuracy increases on specific hardware, etc.), information describing the date the modifications occurred, information describing the user(s) that performed the modifications, and/or information describing any other characteristics and/or modifications associated with the model 104.

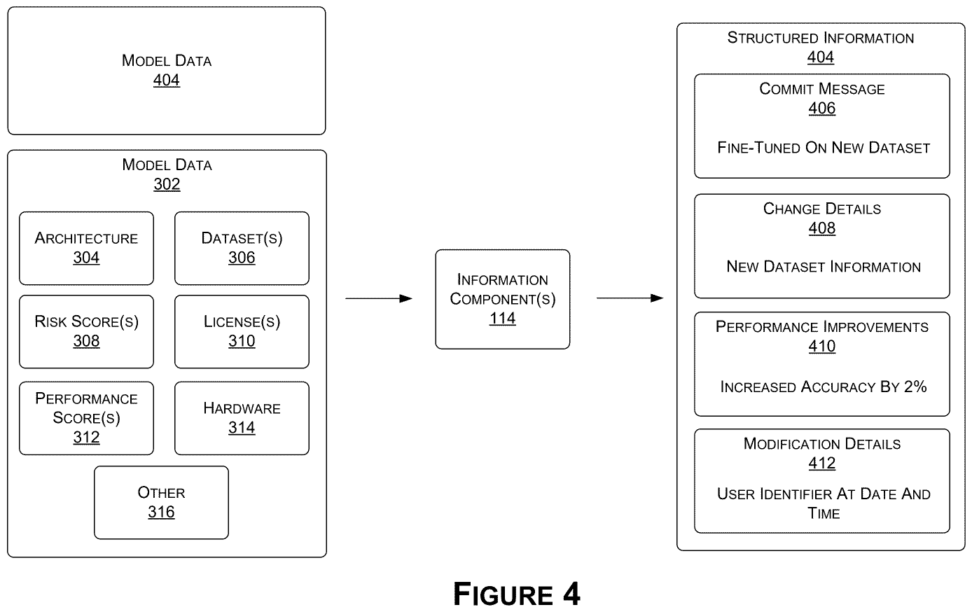

For instance, FIG. 4 illustrates an example of generating structured information associated with a version of a model, in accordance with some embodiments of the present disclosure. As shown, the information component(s) 114 may process at least the model data 302 associated with the sixth version of the model 202(6) and/or model data 402 associated with one or more of the other versions of the model 202(1)-(5). Based at least on the processing, the information component(s) 114 may generate structured information 404 (which may include, and/or be similar to, the structured information 116) associated with the sixth version of the model 202(6). In the example of FIG. 4, the structured information 404 may include at least a commit message 406 indicating that a modification included fine-tuning the model on a new dataset, change details 408 that include information about the new dataset, performance improvements 410 indicating that the accuracy of the model increased by 2%, and modification details 412 indicating an identifier of a user and a date and time that the modification occurred. However, in other examples, the structured information 404 may include additional and/or alternative types of information.

Referring back to the example of FIG. 1, the process 100 may include one or more encoding components 118 encoding at least a portion of the structured information 116 to generate encoded information 120. As described herein, the encoding component(s) 118 may include and/or use any type of encoder to generate the encoded information 120. For example, the encoded information 120 may include Unicode, ISO-8859-1, UTF-16, code page, label encoding, Base64 encoding, and/or any other type of encoded text. While the example of FIG. 1 illustrates the process 100 as including the encoding component(s) 118 generating the encoded information 120, in other examples, the process 100 may not include the encoding component(s) 118 generating the encoded information 120.

The process 100 may include one or more identifier components 122 processing at least a portion of the encoded information 120 (and/or, in some examples, the structured information 116) to generate unique identifiers 124 associated with the models 104, where the unique identifiers 124 are stored in one or more databases 126. As described herein, a unique identifier 124 may include, but is not limited to, a checksum, a hash, a code, an alphabetic identifier, a numerical identifier, an alphanumerical identifier, and/or any other type of identifier that may be used to track modifications associated with a model 104. Additionally, in some examples, the identifier component(s) 122 may include and/or use one or more hashing algorithms (e.g., SHA-256, Blake3, etc.) to generate checksums based at least on the encoded information 120. Furthermore, in some examples, the identifier component(s) 122 may combine the encoded information 120 with additional information when generating the unique identifiers 124. For example, the identifier component(s) 122 may combine the encoded information 120 with information describing configurations 128 of the models 104 and then use the combined information to generate the unique identifiers 124.

In some examples, the identifier component(s) 122 may generate unique identifiers 124 associated with each of the versions of the models 104. For example, each time a new version of a model 104 is uploaded to the database(s) 106, the identifier component(s) 122 may generate a unique identifier 124 associated with the new version of the model 104. However, in some examples, the identifier component(s) 122 may generate one or more unique identifiers 124 associated with one or more specific versions of the models 104. For example, the identifier component(s) 122 may generate unique identifiers 124 for specific types of modifications, such as when models 104 are optimized for specific hardware.

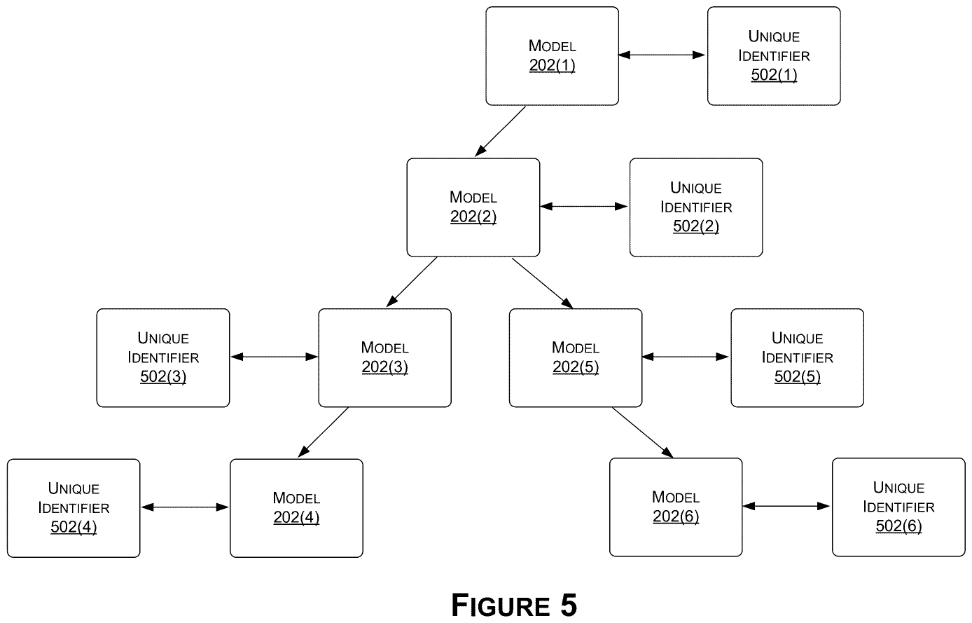

For instance, FIG. 5 illustrates an example of generating unique identifiers associated with the various versions of the model 202(1)-(6), in accordance with some embodiments of the present disclosure. As shown, the identifier component(s) 122 may generate at least a first unique identifier 502(1) associated with the first version of the model 202(1), a second unique identifier 502(2) associated with the second version of the model 202(2), a third unique identifier 502(3) associated with the third version of the model 202(3), a fourth unique identifier 502(4) associated with the fourth version of the model 202(4), a fifth unique identifier 502(5) associated with the fifth version of the model 202(5), and a sixth unique identifier 502(6) associated with the sixth version of the model 202(6). As described herein, the unique identifiers 502(1)-(6) may be associated with characteristics and/or modifications associated with the versions of the model 202(1)-(6). For instance, the sixth unique identifier 502(6) may represent information associated with the fifth modification 204(5) of the fifth version of the model 202(5) to generate the sixth version of the model 202(6). For example, the identifier component(s) 122 may generate the sixth unique identifier 502(6) using the structured information 404.

Referring back to the example of FIG. 1, the process 100 may include storing the models 104 and/or the unique identifiers 124 locally on the system(s) 102. For example, the system(s) may store the unique identifiers 124 in association with the models 104 such that the system(s) 102 is able to later identify the unique identifiers 124 when one or more events occur. Additionally, in some examples, the process 100 may include providing at least some of the models 104 to external repositories 130, where the models 104 provided to the external repositories 130 are represented by models 132, and/or providing at least some of the unique identifiers 124 to the external repositories 130, where the unique identifiers 124 provided to the external repositories 130 are represented by unique identifiers 134. In other words, the system(s) 102 may synchronize the modifications to the models 132 with the external repositories 130 while also providing the external repositories 130 with the associated unique identifiers 134. This way, the external repositories 130 may perform one or more of the processes described herein with respect to the system(s) 102.

As described herein, the system(s) 102, the computing device(s) 108, and/or the external repositories 130 may use the unique identifiers 124 associated with the models 104 to perform one or more tasks. For instance, the process 100 may include using one or more decoding components 136 to decode unique identifiers 124. As described herein, the decoding component(s) 136 may decode unique identifiers 124 based on the occurrence of one or more events. For example, the decoding component(s) 136 may decode unique identifiers 124 based on receiving requests from computing devices 108, receiving the unique identifiers 124 from computing devices 108 (e.g., after the unique identifiers 124 are provided to the computing devices 108 with associated models 104), in response to providing the associated models 104 to computing devices 108, and/or based on any other type of event. Additionally, the decoding component(s) 136 may include and/or use any type of decoder to perform one or more of the processes described herein.

For instance, based on receiving a request to decode a unique identifier 124 associated with a model 104, the decoding component(s) 136 may decode the unique identifier 124 in order to generate and/or retrieve the structured information 116 associated with the model 104. Additionally, in some examples, the decoding component(s) 136 may decode one or more additional unique identifiers 124 associated with one or more additional versions of the model 104. This way, in such examples, the decoding component(s) 136 is able to generate and/or retrieve the structured information 116 representing a clear audit trail associated with the model 104. The system(s) 102 may then provide the structured information 116 associated with the model 104 and/or the structured information 116 associated with one or more additional versions of the model 104 to a computing device 108. Based on receiving the structured information 116, the computing device 108 may then provide (e.g., display, output audio associated with, etc.) the structured information 116 to a user.

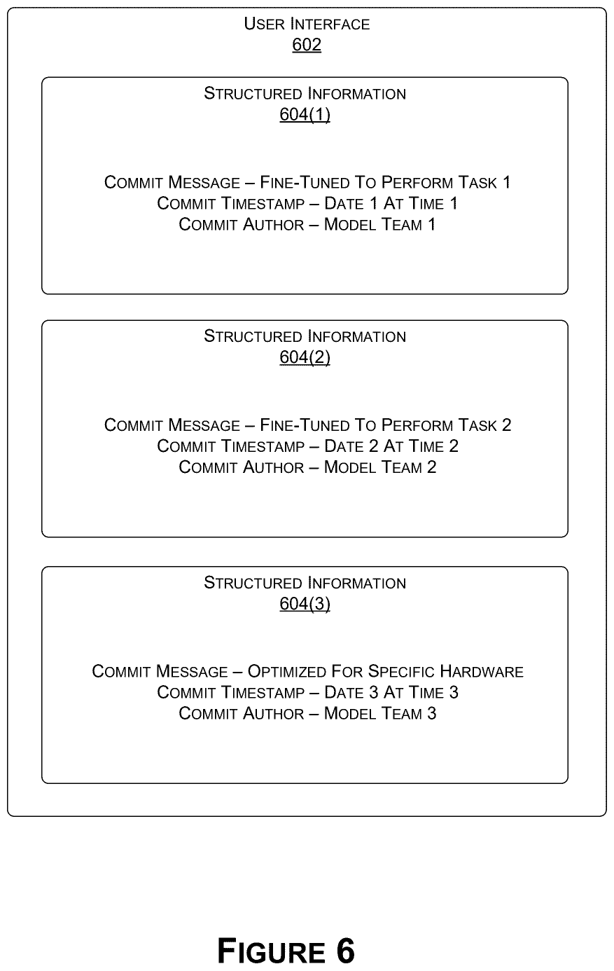

For instance, FIG. 6 illustrates an example of providing structured information associated with various versions of a model, in accordance with some embodiments of the present disclosure. As shown, a user interface 602 may include at least first structured information 604(1) associated with the first modification 204(1) to the first version of the model 202(1) in order to generate the second version of the model 202(2), second structured information 604(2) associated with the second modification 204(2) to the second version of the model 202(2) to generate the third version of the model 202(3), and third structured information 604(3) associated with the third modification 204(3) to the third version of the model 202(3) to generate the fourth version of the model 202(4). For instance, the first structured information 604(1) indicates that the first modification 204(1) included fine-tuning the model to perform task 1, the second structured information 604(2) indicates that the second modification 204(2) included fine-tuning the model to perform task 2, and the third structured information 604(3) indicates that the third modification 204(3) included optimizing the model for specific hardware (e.g., a specific type of processor, a specific type of memory, etc.).

Referring back to the example of FIG. 1, the user may then use the structured information 116 to perform one or more tasks. For a first example, if the user is determining whether to use a version of the model 104 and/or is using the version of the model 104, the user may use the structured information 116 to identify various modifications that occurred to the model 104, a performance of the version of the model 104, a performance of the version of the model 104 on specific hardware, a performance of the version of the model 104 to perform a specific task, users that performed the modifications, times that the modifications occurred with respect to the model 104, and/or any other information that is important to the user. The user may then determine whether to use the version of the model 104—such as to perform on one or more tasks and/or for further modification—using this information.

For a second example, the user may use the structured information 116 to identify a history of the modifications that have occurred with respect to the model 104, such as which changes were made to generate each version of the model 104. The user may then select a version of the model 104 to use based on the structured information 116. For example, if the user determines that the modifications to the model 104 were accurate, adequate, and/or necessary, then the user may determine to use the latest version of the model 104 to perform one or more tasks. However, if the user determines that one or more of the modifications were not accurate, adequate, and/or necessary, then the user may determine to revert the modification(s). As such, the user may further use the structured information 116 to identify a version of the model 104 that does not include the modification(s)—such as the version of the model 104 for which the modification(s) was performed on—and use that version of the model to perform the one or more tasks. In other words, the user may rollback to a version of the model 104 that is before the modification(s).

For instance, and in the example of FIG. 6, the user may use the user interface 602 to determine that the third modification 204(3) included optimizing the model for the specific hardware. However, the user may want to execute the model using a different type of hardware. As such, the user may use the structured information 604(1)-(3) to determine to use the third version of the model 202(3) that has not been optimized for the specific hardware rather than the fourth version of the model 202(4) that is optimized for the specific hardware.

In some examples, the unique identifiers 124 may further be used to verify the integrity of the models 104, such as by verifying that the models 104 were not tampered with and/or that unauthorized modifications did not occur with the models 104. For instance, the system(s) may provide a model 104 along with an associated unique identifier 124 to a computing device 108. The computing device 108 may then use the unique identifier 124 to verify the integrity of the model 104. For a first example, the computing device 108 may compare the received unique identifier 124 to the stored unique identifier 124 on the system(s) 102. Based at least on the comparison, the computing device 108 may verify the integrity of the model 104 when the unique identifiers 124 match and/or not verify the integrity of the model 104 when the unique identifiers 124 do not match. This is because, in some examples, the unique identifiers 124 may not match when the model 104 has been further modified (e.g., tampered with, such as by performing unauthorized modifications).

For a second example, the computing device 108 may perform similar processes as the system(s) 102 to generate a new unique identifier 124 associated with the model 104. The computing device 108 may then again compare the received unique identifier 124 to the new unique identifier 124. Based at least on the comparison, the computing device 108 may again verify the integrity of the model 104 when the unique identifiers 124 match and/or not verify the integrity of the model 104 when the unique identifiers 124 do not match. This is because, in some examples, the new unique identifier 124 may not match with the received unique identifier 124 when the model 104 has been further modified (e.g., tampered with, such as by performing unauthorized modifications). While these are just two example techniques for how a computing device 108 may use a unique identifier 124 to verify an integrity of a model 104, in other examples, a computing device 108 may use additional and/or alternative techniques to verify the integrity of the model 104 using the unique identifier 124.

While the example of FIG. 1 illustrates the system(s) 102 as including the modification component(s) 110, the information component(s) 114, the encoding component(s) 118, the identifier component(s) 122, and the decoding component(s) 136, in other examples, the computing device(s) 108 and/or the external repositories 130 may include the modification component(s) 110, the information component(s) 114, the encoding component(s) 118, the identifier component(s) 122, and the decoding component(s) 136. For instance, the process 100 may be performed using the system(s) 102, the computing device(s) 108, and/or the external repositories 130. Additionally, a component (e.g., the modification component(s) 110, the information component(s) 114, the encoding component(s) 118, the identifier component(s) 122, and the decoding component(s) 136) may include software, hardware, a machine learning model, a neural network, a module, a classifier, an algorithm, an encoder, a decoder, a program, an application, and/or any other type of processing component.

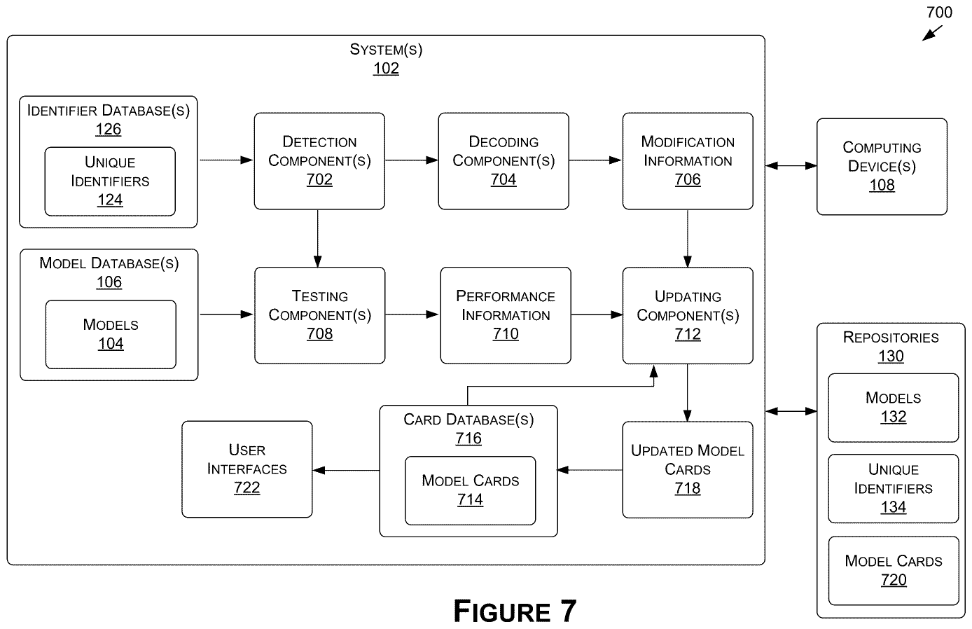

FIG. 7 illustrates an example of a process 700 for automatically updating model cards to include supplemental information for modifications to models, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

For instance, the process 700 may include one or more detection components 702 determining that models 104 are being modified, models 104 were modified, new versions of models 104 were generated, and/or new versions of models 104 were stored in the database(s) 106. In some examples, to determine that a model 104 has been modified, the detection component(s) 702 may use a unique identifier 124 associated with the new version of the model 104. For a first example, the detection component(s) 702 may determine that the unique identifier 124 is being generated and/or is newly generated, such as by using the process 100 from the example of FIG. 1. For instance, and as described herein, unique identifiers 124 may be generated for models 104 when the models 104 are modified in order to track and/or verify the modifications that occur to the models 104.

For a second example, the detection component(s) 702 may determine that the unique identifier 124 is new to the database(s) 126 and/or is different as compared to one or more other unique identifiers 124 associated with one or more previous versions of the model 104. For instance, and as described herein, since the unique identifiers 124 are generated using information describing characteristics associated with the models 104 and/or modifications that occurred to the models 104, each unique identifier 124 is different as compared to the other unique identifiers 124. As such, if the detection component(s) 702 detects a new unique identifier 124 within the database(s) 126, the detection component(s) 702 may determine that the model 104 associated with the unique identifier 124 has been modified. While these are just two example techniques for how the detection component(s) 702 may use the unique identifiers 124 to determine that models 104 have been modified, in other examples, the detection component(s) 702 may use additional and/or alternative techniques.

In some examples, the detection component(s) 702 may use one or more additional and/or alternative techniques to determine that a model 104 is being modified and/or has been modified. For instance, the detection component(s) 104 may determine that a model 104 is being modified and/or has been modified based on determining that a computing device 108 is accessing the model 104, determining a computing device 108 is modifying the model 104, determining a computing device 108 is uploading a new version of the model 104 to the system(s) 102, receiving an indication that the model 104 is being modified, receiving an indication that the model 104 has been modified, receiving an indication that there is the new version of the model 104, and/or using any other technique.

The process 700 may then include one or more decoding components 704 processing unique identifiers 124 to obtain modification information 706 associated with the modifications, where the modification information 706 may also be referred to as supplemental information. For instance, based on determining that a model 104 has been modified to generate a new version of the model 104, the decoding component(s) 704 may decode the unique identifier 124 associated with the model 104 in order to retrieve the structured information 116 describing the characteristics and/or modifications associated with the model 104, where the modification information 706 may include at least a portion of the structured information 116. As described herein, the decoding component(s) 704 may include and/or use any type of decoder to perform one or more of the processes described herein. As such, the process 700 may include using the unique identifier 124 associated with the model 104 to determine that the model 104 was modified and then further using the unique identifier 124 to obtain the modification information 706 describing the modifications associated with the model 104.

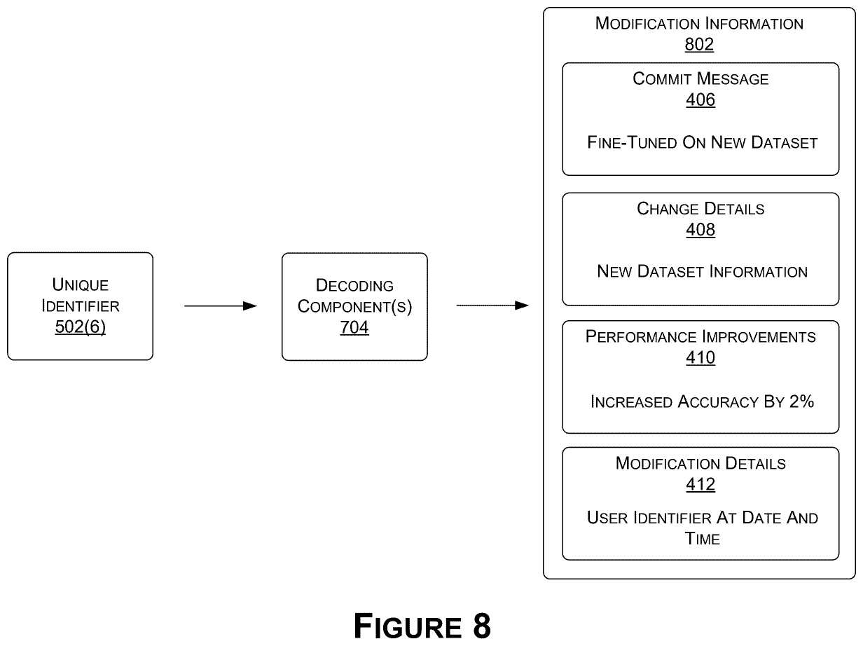

For instance, FIG. 8 illustrates an example of decoding a unique identifier in order to obtain supplemental information associated with a modification to a model, in accordance with some embodiments of the present disclosure. In the example of FIG. 8, the detection component(s) 702 may have initially used the sixth unique identifier 502(6) associated with the sixth version of the model 202(6) to determine that the model was modified. As such, the decoding component(s) 704 may decode the sixth unique identifier 502(6) to obtain modification information 802 describing the fifth modification 204(5) that occurred with respect to the sixth version of the model 202(6). For instance, the modification information 802 may include at least the commit message 406, the change details 408, the performance improvements 410, and/or the modification details 412 from the structured information 404 associated with the sixth version of the model 202(6). However, in other examples, the modification information 802 may include additional and/or alternative information associated with the fifth modification 204(5) to the sixth version of the model 202(6).

Referring back to the example of FIG. 7, the process 700 may include one or more testing components 708 processing the models 104 in order to generate performance information 710 associated with the models 104, where the performance information 710 may also be referred to as supplemental information. For instance, based on determining that a model 104 has been modified, the testing component(s) 708 may perform one or more tests on the new version of the model 104 to determine the performance information 710. As described herein, the performance information 710 associated with the model 104 may include, but is not limited to, an accuracy score, a precision score, a recall score, a loss score, a throughput, a latency, a memory utilization, and/or any other type of performance metric associated with the model 104. Additionally, the testing component(s) 708 may perform any type of test on the model 104 to determine the performance information 710.

For instance, the testing component(s) 708 may input instances of input data into the model 104 for processing. For example, the instances of input data my include images if the model 104 includes a vision model, audio data representing speech if the model 104 includes a language model 104, and/or any other type of input data corresponding to a type of the model 104. The testing component(s) 708 may then obtain outputs based at least on the model 104 processing the input data and use the outputs to determine the performance information 710 associated with the model 104. For example, the testing component(s) 708 may at least determine an accuracy score associated with the model 104 by comparing the outputs from the model 104 to ground truth outputs associated with the input data. While this is just one example technique for how the testing component(s) 708 may test the model 104 to determine the performance information 710, in other examples, the testing component(s) 708 may use additional and/or alternative techniques.

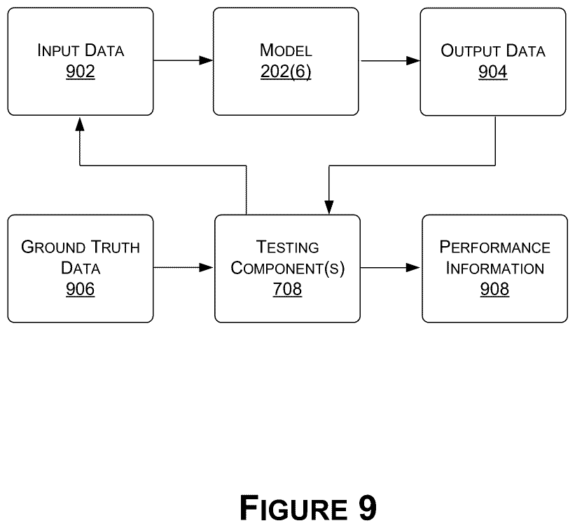

For instance, FIG. 9 illustrates an example of testing a model to determine performance information, in accordance with some embodiments of the present disclosure. As shown, the testing component(s) 708 may input data 902 into the sixth version of the model 202(6). As described herein, the input data 902 may be associated with a type of data for which the sixth version of the model 202(6) is trained to process. For instance, the input data 902 may include image data, video data, audio data, text data, sensor data, and/or any other type of data. The sixth version of the model 202(6) may then process the input data 902 and, based at least on the processing, generate output data 904. The testing component(s) 708 may then use the output data 904 along with ground truth data 906 corresponding to the input data 902 to determine performance information 908 (which may include, and/or be similar to, the performance information 710) associated with the sixth version of the model 202(6).

For instance, the testing component(s) 708 may determine an accuracy score associated with the sixth version of the model 202(6) based at least comparing the output data 904 to the ground truth data 906. For example, the testing component(s) 708 may determine the accuracy score based on a number of outputs that are correct, as determined by comparing the output data 904 to the ground truth data 906, and a total number of outputs. Additionally, in some examples, the testing component(s) 708 may determine additional performance information 908 associated with the sixth version of the model 202(6) based at least on the testing, such as a precision score, a recall score, a loss score, a throughput, a latency, a memory utilization, and/or any other type of performance metric associated with the sixth version of the model 202(6).

Referring back to the example of FIG. 7, the process 700 may include one or more updating components 712 receiving at least the modification information 706 and the performance information 710. In some examples, the updating component(s) 712 may receive additional supplemental information associated with modifications of models 104, such as information represented by the model data 112 from the example of FIG. 1. The process 100 may then include the updating component(s) 712 using at least a portion of the supplemental information to update model cards 714 associated with the models 104, where the model cards 714 are stored in one or more databases 716. As described herein, the updating component(s) 712 may use any technique to update the model cards 714 using the supplemental information.

For instance, model cards 714 may initially include fields that provide initial information associated with first versions of the models 104, such as fields for attributes, model architectures, intended use cases, out-of-scope applications, inputs, outputs, expected users, model performance for different groups, training, limitations, computing requirements, and/or the like. Additionally, an attribute may include, but is not limited to, a name and/or an identifier of a model 104, one or more names and/or identifiers of one or more datasets used to train the model 104, one or more sizes of the dataset(s), a number of epochs used for the training, a license type associated with the model 104, one or more risk scores associated with the model 104, one or more bias scores associated with the model 104, one or more losses associated with the model 104, and/or any other type of attribute. In some examples, the system(s) 102 may automatically generate the model cards 714 when receiving the first versions of the models 104. In some examples, the system(s) 102 may receive the model cards 714 with the first versions of the models 104.

The updating component(s) 712 may then update the model cards 714 to include supplemental information associated with modifications that occurred with respect to the models 104. For instance, the updating component(s) 712 may modify the models cards 714 to include additional fields that represent information related to the modifications, such as types of modifications, the unique identifiers 124 associated with the models 104, the dates of the modifications, the performance information associated with the modifications (e.g., accuracy scores, precision scores, recall scores, etc.), dates when the modified models 104 are deployed, hardware the models 104 are optimized to execute on, performance characteristics associated with the models 104 executing on the hardware (e.g., throughputs, latencies, power consumptions, memory utilizations, etc.), and/or any other information associated with the modifications. In some examples, the updating component(s) 712 may update the model cards 714 with each modification performed on the models 104.

For instance, the updating component(s) 712 may receive supplemental information associated with a new version of a model, such as the modification information 706, the performance information 710, and/or the information represented by the model data 112. The updating component(s) 712 may also receive an identifier associated with the model 104 and/or an identifier associated with a model card 714 corresponding to the model 104. The updating component(s) 712 may then use the identifier(s) to retrieve the model card 714 associated with the model 104. In some examples, the model card 714 may include the initial information associated with the model 104. In some examples, the model card 714 may additionally include supplemental information associated with one or more previous modifications of the model 104. In any of the examples, the updating component(s) 712 may then use at least a portion of the supplemental information to update the model card 714 to include information describing the new version of the model 104 as modified.

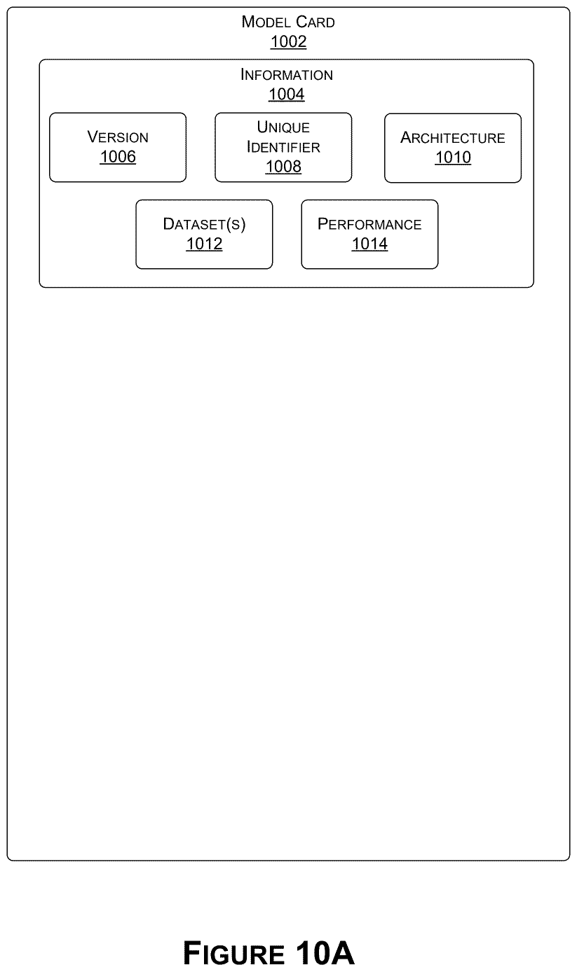

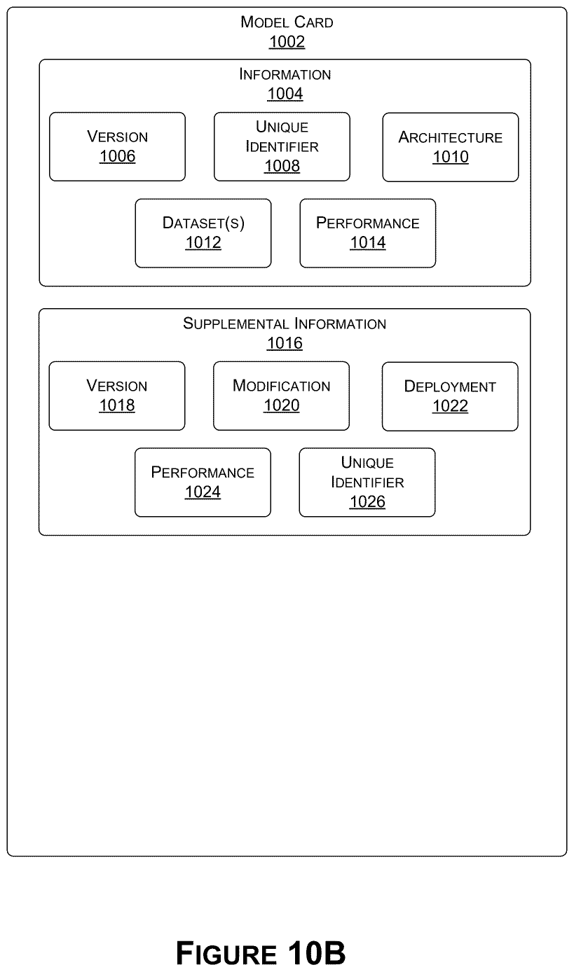

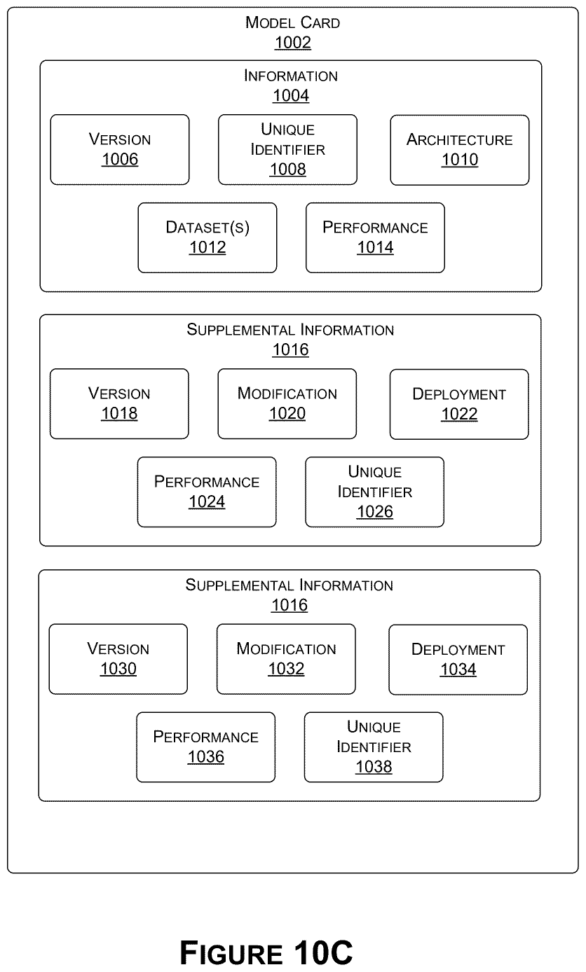

For instance, FIGS. 10A-10C illustrate an example of updating a model card to include supplemental information associated with modifications to a model, in accordance with some embodiments of the present disclosure. As shown by the example of FIG. 10A, a model card 1002 (which may include, and/or be similar to, a model card 714) may initially include information 1004 corresponding to the first version of the model 202(1). For instance, the information 1004 may describe at least a version 1006 of the model, a unique identifier 1008 of the model (e.g., a name, etc.), an architecture 1010 associated with the model, one or more datasets 1012 used to initially train the model, and a performance 1014 of the model. However, in other examples, the information 1004 may include additional and/or alternative fields describing additional and/or alternative characteristics associated with the model.

Next, and as shown by the example of FIG. 10B, the updating component(s) 712 may then receive supplemental information 1016 associated with the first modification 204(1) of the first version of the model 202(1) to generate the second version of the model 202(2). The updating component(s) 712 may then use at least a portion of the supplemental information 1016 to update the model card 1002 to describe the first modification 204(1) and/or the second version of the model 202(2). For instance, and as shown, the supplemental information 1016 may describe at least a version 1018, modification characteristics 1020 (e.g., a type of modification, a date of the modification, an updated accuracy associated with the modification, a deployment date, etc.), deployment characteristics 1022 (e.g., a type of hardware, a throughput, a latency, a memory utilization, etc.), a performance 1024 (e.g., an accuracy score, a precision score, a recall score, etc.), and a unique identifier 1026 (e.g., the second unique identifier 502(2)) associated with the second version of the model 202(2). However, in other examples, the supplemental information 1016 may include additional and/or alternative fields describing additional and/or alternative characteristics associated with the model.

Next, and as shown by the example of FIG. 10C, the updating component(s) 712 may then receive supplemental information 1028 associated with the second modification 204(2) of the second version of the model 202(2) to generate the third version of the model 202(3). The updating component(s) 712 may then use at least a portion of the supplemental information 1028 to update the model card 1002 to describe the second modification 204(2) and/or the third version of the model 202(3). For instance, and as shown, the supplemental information 1028 may describe at least a version 1030, modification characteristics 1032 (e.g., type of modification, a date of the modification, an updated accuracy associated with the modification, a deployment date, etc.), deployment characteristics 1034 (e.g., a type of hardware, a throughput, a latency, a memory utilization, etc.), a performance 1036 (e.g., an accuracy score, a precision score, a recall score, etc.), and a unique identifier 1038 (e.g., the third unique identifier 502(3)) associated with the third version of the model 202(3). However, in other examples, the supplemental information 1028 may include additional and/or alternative fields describing additional and/or alternative characteristics associated with the model.

This process may then continue to repeat in order to update the model card 1002 with supplemental information associated with the third modification 204(3), the fourth version of the model 202(4), the fourth modification 204(4), the fifth version of the model 202(5), the fifth modification 204(5), and/or the sixth version of the model 202(6). While the example of FIGS. 10A-10C describes updating the model card 1002 to include the supplemental information associated with all of the modifications 204(1)-(5) and/or all of the modified versions of the model 202(2)-(6), in other examples, the update component(s) 108 may generate and/or update multiple model cards associated with the model. For example, the update component(s) 108 may generate a first model card that includes information associated with the modifications 204(1)-(3) and the versions of the model 202(1)-(4) and a second model card associated with the modifications 204(4)-(5) and the versions of the model 202(1) and 202(5)-(6).

Referring back to the example of FIG. 7, the process 700 may include the updating component(s) 712 outputting updated model cards 718 associated with the models 104. In some examples, the system(s) 102 may then store the updated model cards 718 in association with the models 104, such as in the database(s) 716. In some examples, the system(s) 102 may further send at least some of the updated model cards 718 to the external repositories 130 for storage, where the updated model cards 718 sent to the external repositories 130 may be represented by model cards 720. In other words, the system(s) 102 may synchronize the updates to the updated model cards 718 with the external repositories 130.

In some examples, the system(s) 102 may then perform one or more operations using the updated model cards 718. For instance, and for a model 104, the system(s) 102 may generate a user interface 722 that includes at least a portion of the updated model card 718 associated with the model 104. As described herein, the system(s) 102 may generate the user interface 722 in response to one or more events, such as receiving a request for the model 104, receiving a request for a version of the model 104, receiving a request for information about the model 104, receiving a request for information about a version of the model 104, and/or any other event. The system(s) 102 may then send data representing the user interface 722 to at least a computing device 108. This way, the computing device 108 may provide the user interface 722 to one or more users that may use the user interface 722 to identify information associated with not only the initial version of the model 104, but also any modified versions of the model 104.

For instance, the user(s) may use the user interface 722 to identify specific modifications that occurred with respect to the model 104. For a first example, if the user(s) is searching for one or more versions of the model 104 that are modified to perform a specific task, such as object detection with regard to a type of object, then the user(s) may use the user interface 722 to identify a version of the model 104 that was trained to perform the specific task. For a second example, if the user(s) is searching for one or more versions of a model 104 that are optimized to execute on specific hardware, such as a type of processor, then the user(s) may use the user interface 722 to identify a version of the model 104 that was optimized for the specific hardware. Still, for a third example, if the user(s) is searching for one or more versions of a model 104 that include a specific performance requirement, such as an accuracy score that is equal to or greater than 95%, then the user(s) may use the user interface 722 to identify a version of the model 104 that satisfies the specific performance requirement.

As described herein, in some examples, the system(s) 102 may provide the updated model cards 718 using various formats. For a first example, the system(s) 102 may generate an updated model card 718 using a text format such that the user interface 722 presents a text file corresponding to the updated model card 718. In such an example, the updated model card 718 may still be searchable, such as by allowing users to input text queries, providing interface elements (e.g., tabs, buttons, etc.) that are selectable to move to different portions of the updated model card 718, and/or using any other technique. For a second example, the system(s) 102 may generate an updated model card 718 using an interactive format such that the user interface 722 allows users to interact with the updated model card 718. For instance, the users may be able to select different portions of the updated model card 718, such as portions corresponding to supplemental information for different modifications to the model 104. Based on selecting a portion of the updated model card 718, the users may then be provided with additional information corresponding to the selected portion.

While the example of FIG. 7 illustrates the system(s) 102 as including the detection component(s) 702, the decoding component(s) 704, the testing component(s) 708, and the updating component(s) 712, in other examples, the computing device(s) 108 and/or the external repositories 130 may include the detection component(s) 702, the decoding component(s) 704, the testing component(s) 708, and the updating component(s) 712. For instance, the process 700 may be performed using the system(s) 102, the computing device(s) 108, and/or the external repositories 130. Additionally, a component (e.g., the detection component(s) 702, the decoding component(s) 704, the testing component(s) 708, and the updating component(s) 712) may include software, hardware, a machine learning model, a neural network, a module, a classifier, an algorithm, an encoder, a decoder, a program, an application, and/or any other type of processing component.

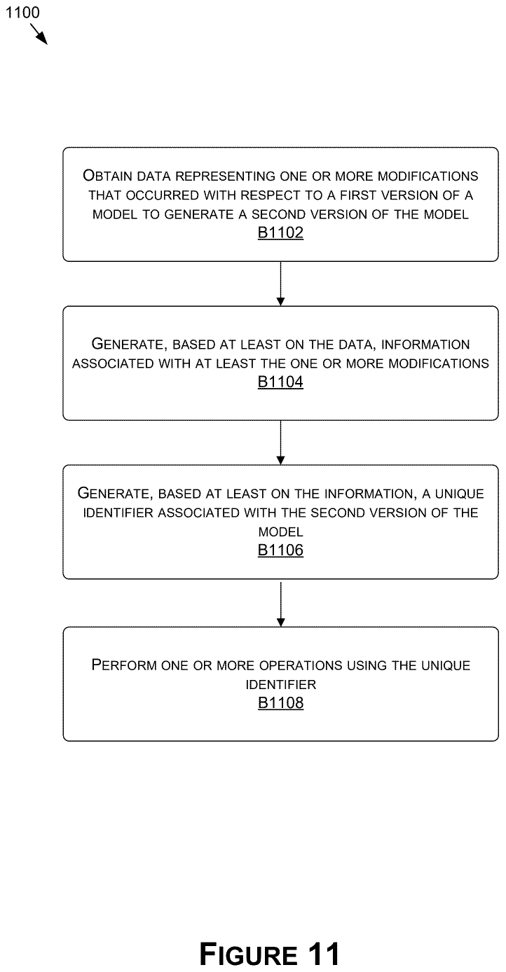

Now referring to FIGS. 11-15, each block of methods 1100, 1200, 1300, 1400, and 1500 described herein, comprises a computing process that may be performed using any combination of hardware, firmware, and/or software. For instance, various functions may be carried out by a processor executing instructions stored in memory. The methods 1100, 1200, 1300, 1400, and 1500 may also be embodied as computer-usable instructions stored on computer storage media. The methods 1100, 1200, 1300, 1400, and 1500 may be provided by a standalone application, a service or hosted service (standalone or in combination with another hosted service), or a plug-in to another product, to name a few. In addition, the methods 1100, 1200, 1300, 1400, and 1500 are described, by way of example, with respect to the system of FIGS. 1 and 7. However, these methods 1100, 1200, 1300, 1400, and 1500 may additionally or alternatively be executed by any one system, or any combination of systems, including, but not limited to, those described herein.

FIG. 11 illustrates a flow diagram showing a method 1100 for generating a unique identifier associated with a modification to a model, in accordance with some embodiments of the present disclosure. The method 1100, at block 1102, may include obtaining data representing one or more modifications that occurred with respect to a first version of a model to generate a second version of the model. For instance, the system(s) 102 (e.g., the modification component(s) 110) may obtain the model data 112 representing the modification(s) that occurred to the first version of the model 104 to generate the second version of the model 104. As described herein, the modification(s) may be performed using one or more computing devices 108 by one or more users. Additionally, the modification(s) may include fine-tuning the model 104 to perform a specific task, optimizing the model 104 to execute using specific hardware components (e.g., processors, memory, etc.), hyperparameter tuning the model 104, performing quantization on the model 104, and/or by performing any other type of model modification technique.

The method 1100, at block B1104, may include generating, based at least on the data, information associated with at least the one or more modifications. For instance, the system(s) 102 (e.g., the information component(s) 114) may use the model data 112 to generate the structured information 116. As described herein, the structured information 116 may include details that describe at least the modification(s) to the first version of the model 104 to generate the second version of the model 104. For instance, the structured information 116 may include, but is not limited to, information describing a summary of the changes made, information describing details about the modification(s) to the model 104, information describing performance improvements associated with the model 104, information describing the date the modification(s) occurred, information describing the user(s) that performed the modification(s), and/or information describing any other characteristics and/or modifications associated with the model 104.

The method 1100, at block B1106, may include generating, based at least on the information, a unique identifier associated with the second version of the model. For instance, the system(s) 102 (e.g., the encoding component(s) 118 and/or the identifier component(s) 122) may generate the unique identifier 124 using at least the structured information 116. As described herein, the system(s) 102 may generate the unique identifier 124 by initially encoding the structured information 116 to generate encoded information 120 and then computing the unique identifier 124 using one or more hashing algorithms. Additionally, in the examples, the system(s) 102 may initially combine the encoded information 120 with a model configuration 128 before computing the unique identifier 124 using the hashing algorithm(s). In some examples, the unique identifier may include a checksum. However, in other examples, the unique identifier may include any other type of identifier.

The method 1100, at block B1108, may include performing one or more operations using the unique identifier. For instance, the system(s) 102 may perform the operation(s) using the unique identifier 124. As described herein, the operation(s) may include, but is not limited to, storing the unique identifier 124 in association with the second version of the model 104, providing the external repositories 130 with the unique identifier 124, decoding the unique identifier 124 to provide one or more users with the structured information 116, verifying an integrity of the second version of the model 104, and/or any other operation.

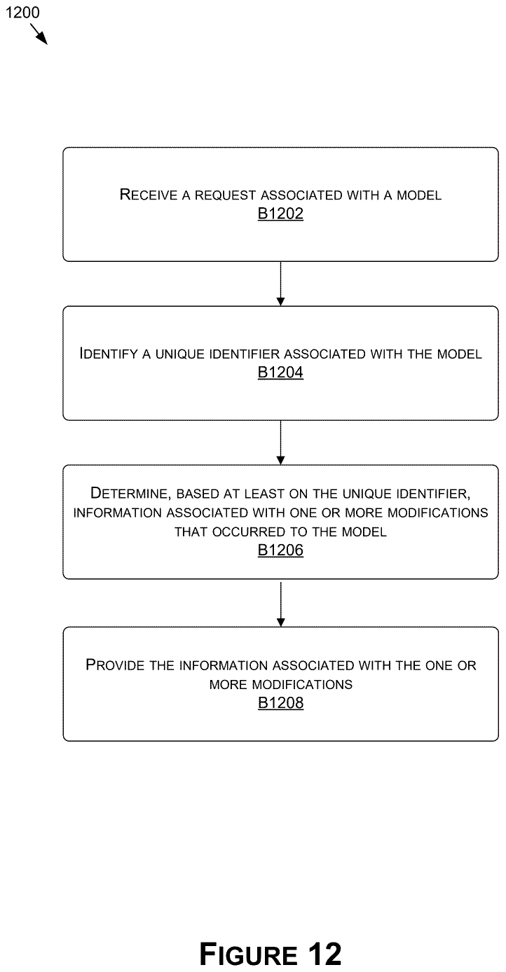

FIG. 12 illustrates a flow diagram showing a method 1200 for using a unique identifier to provide information associated with a model, in accordance with some embodiments of the present disclosure. The method 1200, at block B1202, may include receiving a request associated with a model. For instance, the system(s) 102 may receive the request associated with the model 104 from the computing device 108. In some examples, the request may be associated with accessing and/or using the model 104, retrieving information associated with the model 104, retrieving information associated multiple versions of the model 104, decoding a unique identifier 124 associated with the model 104, and/or any other type of request.

The method 1200, at block B1204, may include identifying a unique identifier associated with the model. For instance, the system(s) 102 may identify the unique identifier 124 associated with the model 104, such as from the database(s) 126. In some examples, the system(s) 102 may also identify one or more additional unique identifiers 124 associated with one or more additional versions associated with the model 104.

The method 1200, at block B1206, may include determining, based at least on the unique identifier, information associated with one or more modifications that occurred to the model. For instance, the system(s) 102 may then use the unique identifier 124 to determine the structured information 116 associated with the model 104. For instance, the system(s) 102 may determine the structured information 116 by decoding the unique identifier 124. Additionally, in some examples, the system(s) may use the additional unique identifier(s) 124 to determine additional structured information 116 associated with the additional version(s) of the model 104.

The method 1200, at block B1208, may include providing the information associated with the one or more modifications. For instance, the system(s) 102 may provide the structured information 116 associated with the model 104. Additionally, in some examples, the system(s) 102 may provide the structured information 116 associated with the additional version(s) of the model 104. In some examples, providing the structured information 116 may include sending the structured information 116 to the computing device 108 for display by the computing device 108.

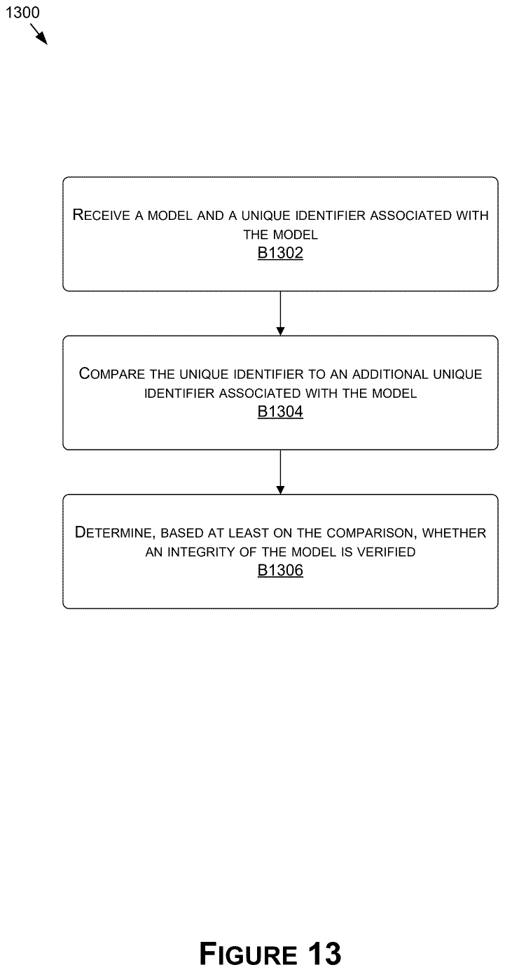

FIG. 13 illustrates a flow diagram showing a method 1300 for using a unique identifier to verify a model, in accordance with some embodiments of the present disclosure. The method 1300, at block B1302, may include receiving a model and a unique identifier associated with the model. For instance, the computing device 108 (and/or an external repository 130) may receive the model 104 and the unique identifier 124 associated with the model 104. As described herein, in some examples, the unique identifier 124 may include a checksum that is generated using the structured information 116 associated with the model 104 and one or more hashing algorithms. However, in other examples, the unique identifier 124 may include any other type of identifier that may be used to verify the integrity of the model 104.

The method 1300, at block B1304, may include comparing the unique identifier to an additional unique identifier associated with the model. For instance, the computing device 108 (and/or the external repository 130) may compare the received unique identifier 124 to the additional unique identifier 124. In some examples, the additional unique identifier 124 may be stored by the system(s) 102. In some examples, the additional unique identifier 124 may be generated by the computing device 108, such as by using a similar process as the system(s) 102 used to generate the received unique identifier 124.

The method 1300, at block B1306, may include determining, based at least on the comparison, whether an integrity of the model is verified. For instance, the computing device 108 (and/or the external repository 130) may determine whether the integrity of the model 104 is verified based at least on the comparing. For example, the computing device 108 may determine that the integrity of the model 104 is verified when the unique identifiers 124 match or determine that the integrity of the model 104 is not verified when the unique identifiers 124 do not match.

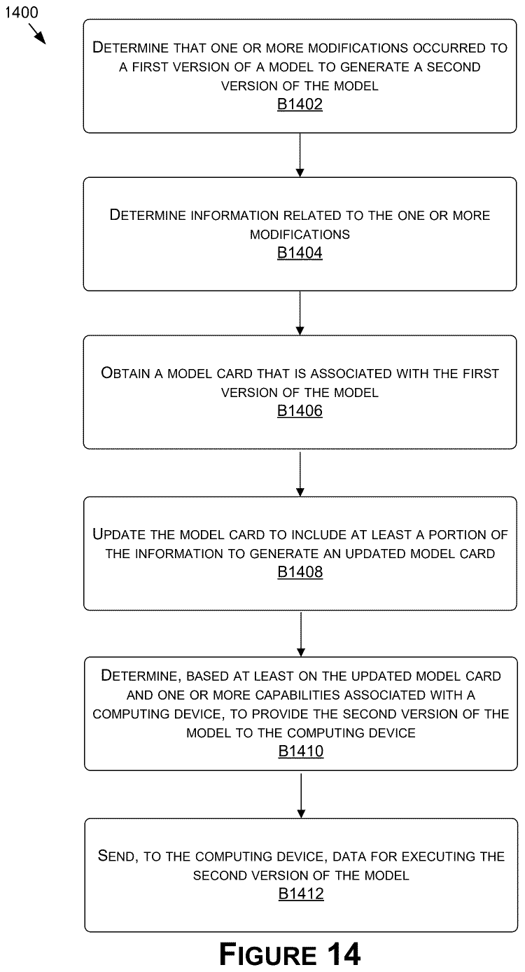

FIG. 14 illustrates a flow diagram showing a method 1400 for updating a model card with information describing a modification to a model, in accordance with some embodiments of the present disclosure. The method 1400, at block B1402, may include determining that one or more modifications occurred to a first version of a model to generate a second version of the model. For instance, the system(s) 102 (e.g., the detection component(s) 702) may determine that the modification(s) occurred to the first version of the model 104 to generate the second version of the model 104. As described herein, in some examples, the system(s) 102 may determine that the modification(s) occurred using the unique identifier 124 associated with the second version of the model 104. In some examples, the system(s) 102 may determine that the modification(s) occurred using another technique, such as the system(s) 102 providing the first version of the model 104 for modification, the system(s) 102 receiving the second version of the model 104, the system(s) receiving an indication that the modification(s) occurred, and/or any other technique.

The method 1400, at block B1404, may include determining information related to the one or more modifications. For instance, the system(s) 102 may determine the supplemental information related to the modification(s). In some examples, the system(s) 102 (e.g., the decoding component(s) 704) may determine at least a portion of the supplemental information, such as the modification information 706, based at least on decoding the unique identifier 124. In some examples, the system(s) 102 (e.g., the testing component(s) 708) may determine at least a portion of the supplemental information, such as the performance information 710, based at least on testing the second version of the model 104. Still, in other examples, the system(s) 102 may use any other technique to determine the supplemental information related to the modification(s).

The method 1400, at block B1406, may include obtaining a model card that is associated with the first version of the model. For instance, the system(s) 102 (e.g., the updating component(s) 712) may obtain the model card 714 associated with the first version of the model 104. In some examples, the system(s) 102 may obtain the model card 714 using an identifier associated with the first version of the model 104 and/or an identifier associated with the model card 714. However, in other examples, the system(s) 102 may use any other technique to obtain the model card 714.

The method 1400, at block B1408, may include updating the model card to include at least a portion of the information to generate an updated model card. For instance, the system(s) 102 (e.g., the updating component(s) 712) may use at least a portion of the supplemental information to update the model card 714 to generate the updated model card 718. In some examples, the system(s) 102 may update the model card 714 by adding text corresponding to the at least the portion of the supplemental information to the model card 714. In some examples, this may continue to repeat such that the updated model card 718 is updated with supplemental information related to one or more additional modifications to the model 104.

The method 1400, at block B1408, may include determining, based at least on the updated model card and one or more capabilities associated with a computing device, to provide the second version of the model to the computing device. For instance, the system(s) 102 may obtain information indicating the one or more capabilities associated with the computing device 108. As described herein, the capabilities may include, but are not limited to, processing capabilities, memory capabilities, network capabilities, and/or any other type of capability. The system(s) 102 may then use the updated model card 718 to determine that the computing device 108 is able to execute the second version of the model 104 based on the one or more capabilities. For example, the system(s) 102 may determine that the one or more capabilities satisfy one or more minimum capabilities for executing the second version of the model 104.

The method 1400, at block B1410, may include sending, to the computing device, data for executing the second version of the model. For instance, the system(s) 102 may send the data for executing the second version of the model 104 to the computing device 108. In some examples, the system(s) 102 sends the data based at least on determining that the computing device 108 is capable of executing the second version of the model 104.

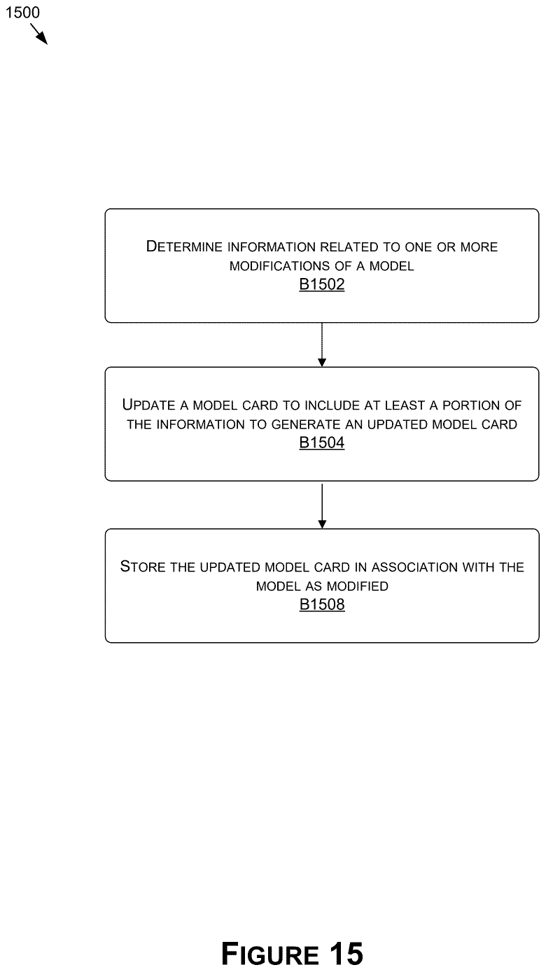

FIG. 15 illustrates a flow diagram showing another method 1500 for updating a model card with information describing a modification to a model, in accordance with some embodiments of the present disclosure. The method 1500, at block B1502, may include determining information related to one or more modifications to a model. For instance, the system(s) 102 (e.g., the detection component(s) 702) may determine that the model 104 has been modified to generate a new version of the model 104. The system(s) 102 may then determine the supplemental information related to the modification(s). In some examples, the system(s) 102 (e.g., the decoding component(s) 704) may determine at least a portion of the supplemental information, such as the modification information 706, based at least on decoding the unique identifier 124. In some examples, the system(s) 102 (e.g., the testing component(s) 708) may determine at least a portion of the supplemental information, such as the performance information 710, based at least on testing the second version of the model 104. Still, in other examples, the system(s) 102 may use any other technique to determine the supplemental information related to the modification(s).

The method 1500, at block B1504, may include updating a model card to include at least a portion of the information to generate an updated model card. For instance, the system(s) 102 (e.g., the updating component(s) 712) may use at least a portion of the supplemental information to update the model card 714 to generate the updated model card 718. In some examples, the system(s) 102 may update the model card 714 by adding text corresponding to the at least the portion of the supplemental information to the model card 714. In some examples, this may continue to repeat such that the updated model card 718 is updated with additional supplemental information related to one or more additional modifications to the model 104.

The method 1500, at block B1506, may include storing the updated model card in association with the model as modified. For instance, the system(s) 102 may store the updated model card 716 in associated with the new version of the model 104. In some examples, the system(s) 102 may also synchronize new version of the model 104 and/or the updated model card 716 with one or more external repositories 130, such as by sending the updated model card 716 and/or the new version of the model 104 to the one or more external repositories 130.

### Example Computing Device

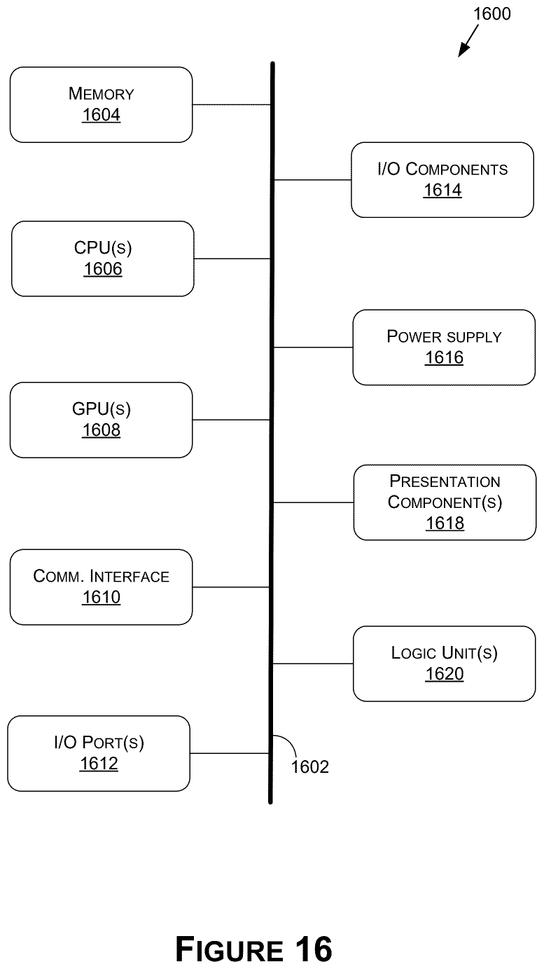

FIG. 16 is a block diagram of an example computing device(s) 1600 suitable for use in implementing some embodiments of the present disclosure. Computing device 1600 may include an interconnect system 1602 that directly or indirectly couples the following devices: memory 1604, one or more central processing units (CPUs) 1606, one or more graphics processing units (GPUs) 1608, a communication interface 1610, input/output (I/O) ports 1612, input/output components 1614, a power supply 1616, one or more presentation components 1618 (e.g., display(s)), and one or more logic units 1620. In at least one embodiment, the computing device(s) 1600 may comprise one or more virtual machines (VMs), and/or any of the components thereof may comprise virtual components (e.g., virtual hardware components). For non-limiting examples, one or more of the GPUs 1608 may comprise one or more vGPUs, one or more of the CPUs 1606 may comprise one or more vCPUs, and/or one or more of the logic units 1620 may comprise one or more virtual logic units. As such, a computing device(s) 1600 may include discrete components (e.g., a full GPU dedicated to the computing device 1600), virtual components (e.g., a portion of a GPU dedicated to the computing device 1600), or a combination thereof.

Although the various blocks of FIG. 16 are shown as connected via the interconnect system 1602 with lines, this is not intended to be limiting and is for clarity only. For example, in some embodiments, a presentation component 1618, such as a display device, may be considered an I/O component 1614 (e.g., if the display is a touch screen). As another example, the CPUs 1606 and/or GPUs 1608 may include memory (e.g., the memory 1604 may be representative of a storage device in addition to the memory of the GPUs 1608, the CPUs 1606, and/or other components). As such, the computing device of FIG. 16 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 16.

The interconnect system 1602 may represent one or more links or busses, such as an address bus, a data bus, a control bus, or a combination thereof. The interconnect system 1602 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1606 may be directly connected to the memory 1604. Further, the CPU 1606 may be directly connected to the GPU 1608. Where there is direct, or point-to-point connection between components, the interconnect system 1602 may include a PCIe link to carry out the connection. In these examples, a PCI bus need not be included in the computing device 1600.

The memory 1604 may include any of a variety of computer-readable media. The computer-readable media may be any available media that may be accessed by the computing device 1600. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1604 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1600. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1606 may be configured to execute at least some of the computer-readable instructions to control one or more components of the computing device 1600 to perform one or more of the methods and/or processes described herein. The CPU(s) 1606 may each include one or more cores (e.g., one, two, four, eight, twenty-eight, seventy-two, etc.) that are capable of handling a multitude of software threads simultaneously. The CPU(s) 1606 may include any type of processor, and may include different types of processors depending on the type of computing device 1600 implemented (e.g., processors with fewer cores for mobile devices and processors with more cores for servers). For example, depending on the type of computing device 1600, the processor may be an Advanced RISC Machines (ARM) processor implemented using Reduced Instruction Set Computing (RISC) or an x86 processor implemented using Complex Instruction Set Computing (CISC). The computing device 1600 may include one or more CPUs 1606 in addition to one or more microprocessors or supplementary co-processors, such as math co-processors.

In addition to or alternatively from the CPU(s) 1606, the GPU(s) 1608 may be configured to execute at least some of the computer-readable instructions to control one or more components of the computing device 1600 to perform one or more of the methods and/or processes described herein. One or more of the GPU(s) 1608 may be an integrated GPU (e.g., with one or more of the CPU(s) 1606 and/or one or more of the GPU(s) 1608 may be a discrete GPU. In embodiments, one or more of the GPU(s) 1608 may be a coprocessor of one or more of the CPU(s) 1606. The GPU(s) 1608 may be used by the computing device 1600 to render graphics (e.g., 3D graphics) or perform general purpose computations. For example, the GPU(s) 1608 may be used for General-Purpose computing on GPUs (GPGPU). The GPU(s) 1608 may include hundreds or thousands of cores that are capable of handling hundreds or thousands of software threads simultaneously. The GPU(s) 1608 may generate pixel data for output images in response to rendering commands (e.g., rendering commands from the CPU(s) 1606 received via a host interface). The GPU(s) 1608 may include graphics memory, such as display memory, for storing pixel data or any other suitable data, such as GPGPU data. The display memory may be included as part of the memory 1604. The GPU(s) 1608 may include two or more GPUs operating in parallel (e.g., via a link). The link may directly connect the GPUs (e.g., using NVLINK) or may connect the GPUs through a switch (e.g., using NVSwitch). When combined together, each GPU 1608 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1606 and/or the GPU(s) 1608, the logic unit(s) 1620 may be configured to execute at least some of the computer-readable instructions to control one or more components of the computing device 1600 to perform one or more of the methods and/or processes described herein. In embodiments, the CPU(s) 1606, the GPU(s) 1608, and/or the logic unit(s) 1620 may discretely or jointly perform any combination of the methods, processes and/or portions thereof. One or more of the logic units 1620 may be part of and/or integrated in one or more of the CPU(s) 1606 and/or the GPU(s) 1608 and/or one or more of the logic units 1620 may be discrete components or otherwise external to the CPU(s) 1606 and/or the GPU(s) 1608. In embodiments, one or more of the logic units 1620 may be a coprocessor of one or more of the CPU(s) 1606 and/or one or more of the GPU(s) 1608.

Examples of the logic unit(s) 1620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMS), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1610 may include one or more receivers, transmitters, and/or transceivers that allow the computing device 1600 to communicate with other computing devices via an electronic communication network, included wired and/or wireless communications. The communication interface 1610 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1620 and/or communication interface 1610 may include one or more data processing units (DPUs) to transmit data received over a network and/or through interconnect system 1602 directly to (e.g., a memory of) one or more GPU(s) 1608.

The I/O ports 1612 may allow the computing device 1600 to be logically coupled to other devices including the I/O components 1614, the presentation component(s) 1618, and/or other components, some of which may be built in to (e.g., integrated in) the computing device 1600. Illustrative I/O components 1614 include a microphone, mouse, keyboard, joystick, game pad, game controller, satellite dish, scanner, printer, wireless device, etc. The I/O components 1614 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1600. The computing device 1600 may be include depth cameras, such as stereoscopic camera systems, infrared camera systems, RGB camera systems, touchscreen technology, and combinations of these, for gesture detection and recognition. Additionally, the computing device 1600 may include accelerometers or gyroscopes (e.g., as part of an inertia measurement unit (IMU)) that allow detection of motion. In some examples, the output of the accelerometers or gyroscopes may be used by the computing device 1600 to render immersive augmented reality or virtual reality.

The power supply 1616 may include a hard-wired power supply, a battery power supply, or a combination thereof. The power supply 1616 may provide power to the computing device 1600 to allow the components of the computing device 1600 to operate.

The presentation component(s) 1618 may include a display (e.g., a monitor, a touch screen, a television screen, a heads-up-display (HUD), other display types, or a combination thereof), speakers, and/or other presentation components. The presentation component(s) 1618 may receive data from other components (e.g., the GPU(s) 1608, the CPU(s) 1606, DPUs, etc.), and output the data (e.g., as an image, video, sound, etc.).

### Example Data Center

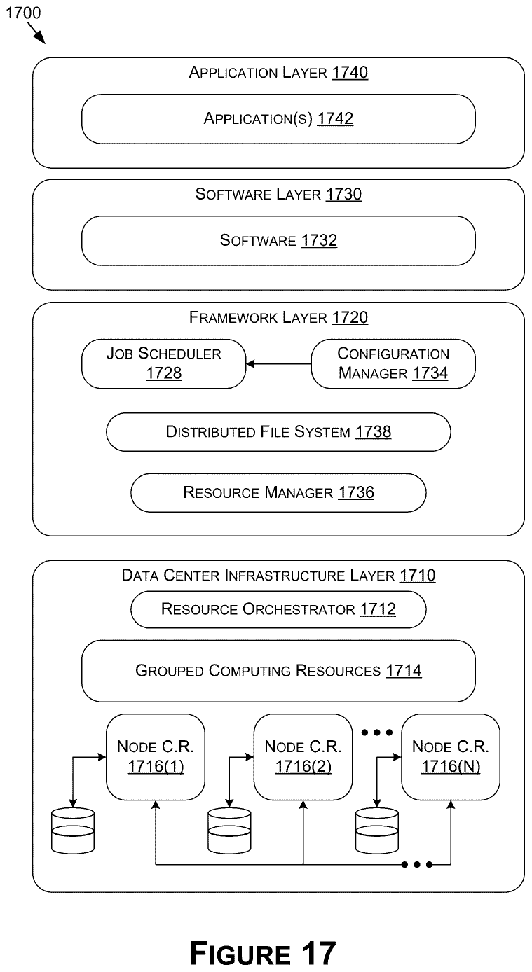

FIG. 17 illustrates an example data center 1700 that may be used in at least one embodiments of the present disclosure. The data center 1700 may include a data center infrastructure layer 1710, a framework layer 1720, a software layer 1730, and/or an application layer 1740.

As shown in FIG. 17, the data center infrastructure layer 1710 may include a resource orchestrator 1712, grouped computing resources 1714, and node computing resources (“node C.R.s”) 1716(1)-1716(N), where “N” represents any whole, positive integer. In at least one embodiment, node C.R.s 1716(1)-1716(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1716(1)-1716(N) may correspond to a server having one or more of the above-mentioned computing resources. In addition, in some embodiments, the node C.R.s 1716(1)-17161(N) may include one or more virtual components, such as vGPUs, vCPUs, and/or the like, and/or one or more of the node C.R.s 1716(1)-1716(N) may correspond to a virtual machine (VM).

In at least one embodiment, grouped computing resources 1714 may include separate groupings of node C.R.s 1716 housed within one or more racks (not shown), or many racks housed in data centers at various geographical locations (also not shown). Separate groupings of node C.R.s 1716 within grouped computing resources 1714 may include grouped compute, network, memory or storage resources that may be configured or allocated to support one or more workloads. In at least one embodiment, several node C.R.s 1716 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1712 may configure or otherwise control one or more node C.R.s 1716(1)-1716(N) and/or grouped computing resources 1714. In at least one embodiment, resource orchestrator 1712 may include a software design infrastructure (SDI) management entity for the data center 1700. The resource orchestrator 1712 may include hardware, software, or some combination thereof.

In at least one embodiment, as shown in FIG. 17, framework layer 1720 may include a job scheduler 1728, a configuration manager 1734, a resource manager 1736, and/or a distributed file system 1738. The framework layer 1720 may include a framework to support software 1732 of software layer 1730 and/or one or more application(s) 1742 of application layer 1740. The software 1732 or application(s) 1742 may respectively include web-based service software or applications, such as those provided by Amazon Web Services, Google Cloud and Microsoft Azure. The framework layer 1720 may be, but is not limited to, a type of free and open-source software web application framework such as Apache Spark™ (hereinafter “Spark”) that may use distributed file system 1738 for large-scale data processing (e.g., “big data”). In at least one embodiment, job scheduler 1728 may include a Spark driver to facilitate scheduling of workloads supported by various layers of data center 1700. The configuration manager 1734 may be capable of configuring different layers such as software layer 1730 and framework layer 1720 including Spark and distributed file system 1738 for supporting large-scale data processing. The resource manager 1736 may be capable of managing clustered or grouped computing resources mapped to or allocated for support of distributed file system 1738 and job scheduler 1728. In at least one embodiment, clustered or grouped computing resources may include grouped computing resource 1714 at data center infrastructure layer 1710. The resource manager 1736 may coordinate with resource orchestrator 1712 to manage these mapped or allocated computing resources.

In at least one embodiment, software 1732 included in software layer 1730 may include software used by at least portions of node C.R.s 1716(1)-1716(N), grouped computing resources 1714, and/or distributed file system 1738 of framework layer 1720. One or more types of software may include, but are not limited to, Internet web page search software, e-mail virus scan software, database software, and streaming video content software.

In at least one embodiment, application(s) 1742 included in application layer 1740 may include one or more types of applications used by at least portions of node C.R.s 1716(1)-1716(N), grouped computing resources 1714, and/or distributed file system 1738 of framework layer 1720. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1734, resource manager 1736, and resource orchestrator 1712 may implement any number and type of self-modifying actions based on any amount and type of data acquired in any technically feasible fashion. Self-modifying actions may relieve a data center operator of data center 1700 from making possibly bad configuration decisions and possibly avoiding underutilized and/or poor performing portions of a data center.

The data center 1700 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1700. In at least one embodiment, trained or deployed machine learning models corresponding to one or more neural networks may be used to infer or predict information using resources described above with respect to the data center 1700 by using weight parameters calculated through one or more training techniques, such as but not limited to those described herein.

In at least one embodiment, the data center 1700 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1600 of FIG. 16—e.g., each device may include similar components, features, and/or functionality of the computing device(s) 1600. In addition, where backend devices (e.g., servers, NAS, etc.) are implemented, the backend devices may be included as part of a data center 1700, an example of which is described in more detail herein with respect to FIG. 17.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1600 described herein with respect to FIG. 16. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: obtaining data representing one or more modifications that occurred with respect to a first version of a model to generate a second version of the model; generating, based at least on the data representing the one or more modifications, a checksum for the second version of the model; and providing, to one or more computing devices, the second version of the model along with the checksum, wherein the second version of the model may be verified using the checksum.
B: The method of paragraph A, wherein the data representing the one or more modifications represents at least one of: an architecture associated with the second version of the model; a dataset used to train the second version of the model; a risk score associated with the second version of the model; a license associated with the second version of the model; a performance score associated with the second version of the model; or one or more types of hardware for which the second version of the model was optimized.
C: The method of either paragraph A or paragraph B, wherein the generating the checksum for the second version of the model comprises: generating, based at least on the data representing the one or more modifications, information that describes the one or more modifications; and determining the checksum associated with the second version of the model based at least on the information.
D: The method of paragraph C, wherein the determining the checksum associated with the second version of the model based at least on the information comprises: encoding the information to generate encoded information; and applying one or more algorithms to the encoded information to obtain the checksum associated with the second version of the model.
E: The method of paragraph C, wherein the information that describes the one or more modifications comprises at least one of: first text describing the one or more modifications; second text describing a dataset used to perform the one or more modifications; third text describing a change in performance associated with the second version of the model; fourth text describing a time that the one or more modifications occurred; fifth text describing one or more users that performed the one or more modifications; or sixth text describing hardware that performed the one or more modifications.
F: The method of any one of paragraphs A-E, further comprising: determining, based at least on the checksum, information describing the one or more modifications; and providing the information to the one or more computing devices.
G: The method of any one of paragraphs A-F, further comprising: providing the first version of the model to one or more second computing devices, wherein the obtaining the data representing the one or more modifications is based at least the first version of the model being modified using the one or more second computing devices.
H: The method of any one of paragraphs A-G, further comprising: obtaining second data representing one or more second modifications that occurred with respect to one of the first version of the model or the second version of the model to generate a third version of the model; generating, based at least on the second data representing the one or more second modifications, a second checksum associated with the third version of the model; and storing the second checksum in association with the third version of the model.
I: The method of any one of paragraphs A-H, wherein the one or more modifications are associated with at least one of: finetuning the first version of the model to generate the second version of the model; optimizing the first version of the model for one or more hardware components; or performing quantization on the first version of the model to generate the second version of the model.
J: A system comprising: one or more processors to: provide a first version of a model to one or more computing devices; obtain, based at least on the first version of the model being modified using the one or more computing devices, data representing one or more modifications that occurred to generate a second version of the model; generate, based at least on the data, a unique identifier for the second version of the model; and store the unique identifier in association with the second version of the model.
K: The system of paragraph J, wherein the one or more processors are further to: provide the unique identifier along with the second version of the model to one or more second computing devices, wherein the second version of the model may be verified using the unique identifier.
L: The system of either paragraph J or paragraph K, wherein the one or more processors are further to: generate, based at least on the data, information describing the one or more modifications, wherein the unique identifier is generated based at least on the information.
M: The system of paragraph L, wherein the generation of the unique identifier for the second version of the model comprises: encoding the information to generate encoded information; and generating, based at least on hashing the encoded information using one or more algorithms, the unique identifier associated with the second version of the model.
N: The system of any one of paragraphs J-M, wherein the one or more processors are further to: determine, based at least on the unique identifier, information describing the one or more modifications; and providing the information along with the second version of the model to the one or more second computing devices.
O: The system of any one of paragraphs J-N, wherein the one or more processors are further to: provide the second version of the model to one or more second computing devices; obtain, based at least on the second version of the model being modified using the one or more second computing devices, data representing one or more second modifications that occurred to generate a third version of the model; generate, based at least on the data, a second unique identifier associated with the third version of the model; and store the second unique identifier in association with the third version of the model.
P: The system of paragraph O, wherein the one or more processors are further to: provide, to one or more computing devices and using the unique identifier, first information describing the one or more modifications; provide, to the one or more computing devices and using the second unique identifier, second information describing the one or more second modifications; receiving, from the one or more computing devices, a request for the second version of the model; and providing, to the one or more computing devices and based at least on the request, the second version of the model.
Q: The system of any one of paragraphs J-P, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device' a system implemented using a robot; a system for performing one or more generative AI operations; a system for performing one or more operations using one or more small language models; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.
R: One or more processors comprising: processing circuitry to: generate information describing one or more modifications that occurred to a first version of a model to generate a second version of the model; generate, based at least on the information, a unique identifier for the second version of the model; and store the unique identifier in association with the second version of the model.
S: The one or more processors of paragraph R, wherein the unique identifier is generated by: encoding the information to generate encoded information; and applying one or more algorithms to the encoded information to obtain the unique identifier for the second version of the model.
T: The one or more processors of either paragraph R or paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device' a system implemented using a robot; a system for performing one or more generative AI operations; a system for performing one or more operations using one or more small language models; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.
U: A method comprising: determining that one or more modifications occurred to a first version of a model to generate a second version of the model; obtaining a model card that is associated with the first version of the model; updating the model card to include at least a portion of information related to one or more modifications to generate an updated model card; determining, based at least on the updated model card and one or more capabilities associated with a computing device, to provide the second version of the model to the computing device; and transmitting, to the computing device, data for executing the second version of the model.
V: The method of paragraph U, further comprising: obtaining a unique identifier associated with the second version of the model, wherein the determining that the one or more modifications occurred to the first version of the model is based at least on the unique identifier.
W: The method of either paragraph U or paragraph V, wherein the information related to the one or more modifications is determined by: obtaining a unique identifier associated with the second version of the model, processing the unique identifier to determine the information related to the one or more modifications.
X: The method of any one of paragraphs U-W, wherein the information related to the one or more modifications is determined by: executing one or more performance tests associated with the second version of the model; and identifying, based at least on the one or more performance tests, the information related to the one or more modifications.
Y: The method of any one of paragraphs U-X, wherein the information related to the one or more modifications comprises at least one of: first information indicating a type of modification that occurred to the first version of the model; second information indicating a time that the one or more modifications occurred; third information indicating one or more hardware components for which the second version of the model was optimized; fourth information indicating one or more performance characteristics associated with executing the second version of the model using the one or more hardware components; fifth information indicating one or more performance characteristics associated with the second version of the model; or a unique identifier associated with the second version of the model.
Z: The method of any one of paragraphs U-Y, further comprising: obtaining second information related to one or more second modifications that occurred to the second version of the model to generate a third version of the model; and updating the updated model card to include at least a portion of the second information.
AA: The method of any one of paragraphs U-Z, further comprising at least one of: storing the updated model card in associated with the second version of the model; or providing at least one of the second version of the model or the updated model card to one or more systems.
AB: A system comprising: one or more processors to: determine information related to one or more modifications that occurred to a first version of a model to generate a second version of the model; access a model card that is associated with the first version of the model; update the model card to include at least a portion of the information to generate an updated model card; and store the updated model card in association with the second version of the model.
AC: The system of paragraph AB, wherein the one or more processors are further to: determine, based at least on the updated model card and one or more capabilities associated with a computing device, to provide the second version of the model to the computing device; and send, to the computing device, data for executing the second version of the model.
AD: The system of either paragraph AB or paragraph AC, wherein the one or more processors are further to: obtain a unique identifier associated with the second version of the model; and determine, based at least on the unique identifier, that the one or more modifications occurred to the first version of the model, wherein the model card is updated based at least on the determination that the one or more modifications occurred.
AE: The system of any one of paragraphs AB-AD, wherein the information related to the one or more modifications is determined by: obtaining a unique identifier associated with the second version of the model, processing the unique identifier to determine the information related to the one or more modifications.
AF: The system of any one of paragraphs AB-AE, wherein the information related to the one or more modifications is determined by: performing one or more performance tests associated with the second version of the model; and determining, based at least on the one or more performance tests, the information related to the one or more modifications.
AG: The system of any one of paragraphs AB-AF, wherein the information related to the one or more modifications is determined by: obtaining data associated with performing the one or more modifications to generate the second version of the model; and determining, based at least on the data, the information related to the one or more modifications.
AH: The system of any one of paragraphs AB-AG, wherein the information related to the one or more modifications comprises at least one of: first information indicating a type of modification that occurred to the first version of the model; second information indicating a time that the one or more modifications occurred; third information indicating one or more hardware components for which the second version of the model was optimized; fourth information indicating one or more performance characteristics associated with executing the second version of the model using the one or more hardware components; fifth information indicating one or more performance characteristics associated with the second version of the model; or a unique identifier associated with the second version of the model.
AI: The system of any one of paragraphs AB-AH, wherein the one or more processors are further to: determine second information related to one or more second modifications that occurred to the first version of the model to generate a third version of the model; and update the updated model card to include at least a portion of the second information.
AJ: The system of paragraph AI, wherein: the one or more modifications are associated with optimizing the second version of the model using a first type of hardware; the at least the portion of the information indicates one or more first performance characteristics associated with executing the second version of the model on the first type of hardware; the one or more second modifications are associated with optimizing the third version of the model using a second type of hardware; and the at least the portion of the second information indicates one or more second performance characteristics associated with executing the second version of the model on the second type of hardware.
AK: The system of any one of paragraphs AB-AJ, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device' a system implemented using a robot; a system for performing one or more generative AI operations; a system for performing one or more operations using one or more small language models; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.
AL: One or more processors comprising: processing circuitry to: obtain a unique identifier associated with a version of a model; determine, based at least on the unique identifier, information related to one or more modifications to a previous version of the model to generate the version of the model; update a model card associated with the previous version of the model using at least a portion of the information to generate an updated model card; and store the updated model card in association with the version of the model.
AM: The one or more processors of paragraph AL, wherein the processing circuitry is further to: determine, based at least on the updated model card and one or more capabilities associated with a computing device, to provide the version of the model to the computing device; and send, to the computing device, data for executing the second version of the model.
AN: The one or more processors of either paragraph AL or paragraph AM, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system that provides one or more cloud gaming applications; a system for performing one or more deep learning operations; a system implemented using an edge device' a system implemented using a robot; a system for performing one or more generative AI operations; a system for performing one or more operations using one or more small language models; a system for performing operations using one or more large language models (LLMs); a system for performing operations using one or more vision language models (VLMs); a system for performing operations using one or more multi-modal language models; a system for performing one or more conversational AI operations; a system for generating synthetic data; a system for presenting at least one of virtual reality content, augmented reality content, or mixed reality content; systems implementing one or more multi-modal language models; systems using or deploying one or more inference microservices; systems that incorporate deploy one or more machine learning models in a service or microservice along with an OS-level virtualization package (e.g., a container); a system incorporating one or more virtual machines (VMs); a system implemented at least partially in a data center; or a system implemented at least partially using cloud computing resources.

1. A method comprising:
obtaining a unique identifier associated with a model, the unique identifier being generated by applying a hashing algorithm to encoded modification data that represents one or more modifications;
determining, based at least on decoding the unique identifier using one or more decoders, that the unique identifier represents the one or more modifications that occurred to a first version of the model to generate a second version of the model;
obtaining a model card that is associated with the first version of the model;
updating the model card to include at least first information related to the one or more modifications to generate an updated model card;
receiving, from a computing device, a request associated with the model along with second information indicating one or more capabilities associated with the computing device;
determining, based at least on the updated model card and the one or more capabilities associated with the computing device, to provide the second version of the model to the computing device; and
sending, to the computing device, data for executing the second version of the model.

2. The method of claim 1, wherein the unique identifier is further encoded to represent third information indicating a configuration associated with the second version of the model.

3. The method of claim 1, further comprising sending, to the computing device, the unique identifier for verifying an integrity of the second version of the model by the computing device.

4. The method of claim 1, further comprising:
executing one or more performance tests associated with the second version of the model; and
identifying, based at least on the one or more performance tests, performance information related to the second version of the model,
wherein the updating the model card further uses at least a portion of the performance information.

5. The method of claim 1, wherein the first information related to the one or more modifications indicates at least one of:
a type of modification that occurred to the first version of the model;
a time that the one or more modifications occurred;
one or more hardware components for which the second version of the model was optimized;
one or more performance characteristics associated with executing the second version of the model using the one or more hardware components;
one or more performance characteristics associated with the second version of the model; or
the unique identifier associated with the second version of the model.

6. The method of claim 1, further comprising:
obtaining third information related to one or more second modifications that occurred to the second version of the model to generate a third version of the model; and
updating the updated model card to include at least a portion of the third information.

7. The method of claim 1, further comprising at least one of:
storing the updated model card in associated with the second version of the model; or
providing at least one of the second version of the model or the updated model card to one or more systems.

8. A system comprising:
one or more processors to:
determine that one or more modifications occurred to a first version of a model to generate a second version of the model;
based at least on the one or more modifications occurring, performing one or more performance tests by at least processing one or more instances of training data using the second version of the model to generate one or more outputs that are compared to one or more ground truth outputs;
determine, based at least on the one or more performance tests, performance information related to the second version of the model;
access a model card that is associated with the first version of the model;
update the model card to include at least a portion of the performance information to generate an updated model card;
determine, based at least on the updated model card, to provide the second version of the model to a computing device; and
send, to the computing device, data for executing the second version of the model.

9. (canceled)

10. The system of claim 8, wherein the one or more processors are further to:
obtain a unique identifier associated with the second version of the model, wherein to determine that the one or more modifications occurred to the first version of the model to generate the second version of the model is based at least on the unique identifier.

11. The system of claim 8, wherein the one one or more processors are further to:
obtain a first unique identifier associated with the first version of the model and a second unique identifier associated with the second version of the model,
wherein to determine that the one or more modifications occurred to the first version of the model to generate the second version of the model is based at least on the first unique identifier and the second unique identifier.

12. (canceled)

13. The system of claim 8, wherein the one or more processors are further to:
obtain data associated with performing the one or more modifications to generate the second version of the model,
wherein to determine that the one or more modifications occurred to the first version of the model to generate the second version of the model is based at least on the data associated with performing the one or more modifications.

14. The system of claim 8, wherein the one or more processors are further to obtain information related to the one or more modifications, the information including at least one of:
first information indicating a type of modification that occurred to the first version of the model;
second information indicating a time that the one or more modifications occurred;
third information indicating one or more hardware components for which the second version of the model was optimized;
fourth information indicating one or more performance characteristics associated with executing the second version of the model using the one or more hardware components;
fifth information indicating one or more performance characteristics associated with the second version of the model; or
a unique identifier associated with the second version of the model.

15. The system of claim 8, wherein the one or more processors are further to:
determine information related to one or more second modifications that occurred to the first version of the model to generate a third version of the model; and
further update the updated model card to include at least a portion of the information.

16. The system of claim 15, wherein:
the one or more modifications are associated with optimizing the second version of the model using a first type of hardware;
the at least the portion of the performance information indicates one or more first performance characteristics associated with executing the second version of the model on the first type of hardware;
the one or more second modifications are associated with optimizing the third version of the model using a second type of hardware; and
the at least the portion of the information indicates one or more second performance characteristics associated with executing the third version of the model on the second type of hardware.

17. The system of claim 8, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing one or more operations using one or more small language models (SLMs);
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

18. One or more processors comprising:
processing circuitry to:
determine that one or more modifications occurred to a previous version of a model to generate a current version of the model;
obtain a unique identifier associated with the current version of the model;
determine, based at least on the unique identifier, information related to the one or more modifications that occurred to the previous version of the model to generate the current version of the model;
update a model card associated with the previous version of the model using at least a portion of the information to generate an updated model card associated with the current version of the model,
provide, to a computing device, a user interface that includes at least the portion of the information represented by the updated model card associated with the current version of the model card; and
send, to the computing device and based at least on receiving a request using the user interface, data for executing the current version of the model.

19. (canceled)

20. The one or more processors of claim 18, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system that provides one or more cloud gaming applications;
a system for performing one or more deep learning operations;
a system implemented using an edge device;
a system implemented using a robot;
a system for performing one or more generative AI operations;
a system for performing one or more operations using one or more small language models (SLMs);
a system for performing operations using one or more large language models (LLMs);
a system for performing operations using one or more vision language models (VLMs);
a system for performing operations using one or more multi-modal language models;
a system for performing one or more conversational AI operations;
a system for generating synthetic data;
a system for presenting at least one of virtual reality content, augmented reality content, or mixed reality content;
systems implementing one or more multi-modal language models;
systems using or deploying one or more inference microservices;
systems that incorporate deploy one or more machine learning models in a service or microservice along with an OS-level virtualization package (e.g., a container);
a system incorporating one or more virtual machines (VMs);
a system implemented at least partially in a data center; or
a system implemented at least partially using cloud computing resources.

21. The method of claim 1, wherein the unique identifier is associated with the second version of the model, and the method further comprises:
obtaining a second unique identifier is associated with the first version of the model; and
determining that the first version of the model was updated to the second version of the model based at least on the unique identifier and the second unique identifier.

22. The method of claim 21, wherein the unique identifier is different than the second unique identifier based at least on a first configuration associated with the first version of the model being different than a second configuration associated with the second version of the model.

23. The one or more processors of claim 18, wherein the user interface inhibits selection of a model version of the model based at least on one or more hardware parameters extracted from the updated model card being incompatible with one or more capabilities of the computing device.
